(19) United States
(12) Patent Application Publication
(10) Pub. No.: US 2026/0267398 A1
(43) Pub. Date: Sep. 10, 2026

(54) Management of Power States of Devices and Systems

(71) Applicant: Google LLC, Mountain View, CA (US)

(72) Inventors: Harsha Priya Narasapuram Venkatarama Gupta, Santa Clara, CA (US); Mukesh Agrawal, San Francisco, CA (US); Jonathan Dillinger, Mountain View, CA (US); Andres Alejandro Oportus Valenzuela, Long Grove, IL (US); Adam Barth, Palo Alto, CA (US); Kevin Krister Lindkvist, Ystad (SE); Kit Lane, Denver, CO (US); Justin Charles Mattson, San Francisco, CA (US); Kyle Forrest Gong, San Francisco, CA (US); Michael Tre'Onnis Brunson, II, Lexington, SC (US)

(21) Appl. No.: 19/288,550

(22) Filed: Aug. 1, 2025

Related U.S. Application Data
(60) Provisional application No. 63/768,292, filed on Mar. 7, 2025.

(51) Int. Cl. G06F 1/3293

(52) U.S. Cl. CPC G06F 1/3293

(57) ABSTRACT

Aspects of the disclosed technology provide power savings via managing power states of hardware of electronic devices. By managing these power states, power consumption, functionality and/or wake latency of electronic devices may be improved over other approaches. Aspects of the disclosed technology include optimizing management of parasitic workloads to improve overall power efficiency of wearable devices, thereby improving device performance. Aspects of the technology include an operating system (OS) serving as a supervisor for another OS.

### CROSS-REFERENCE TO RELATED APPLICATIONS

This application claims the benefit of the filing date and priority to U.S. Provisional Patent Application No. 63/768,292, filed Mar. 7, 2025, the entire disclosure of which is incorporated by reference herein.

### BACKGROUND

An important problem of system power management is supporting transitions of various system elements (e.g., hardware and/or software having one or more power states) from one power state to another power state while managing interdependencies associated with those power states. A task of system suspension is ensuring that hardware components are placed in appropriate lower power states before one or more processors stop executing instructions. Superficially, this might appear to be a dependency-management problem that is one layer deep: active states of hardware components are dependent on active states of one or more processors. Thus, hardware components must be transitioned to lower power states (e.g., suspended states) before those processors are transitioned to lower power states (e.g., suspended states). However, viewing this as a one-layer deep dependency-management problem, fails to consider that one or more hardware components may be dependent on each other.

By way of example, hardware components may need to be transitioned to lower power states (e.g., suspended states) before buses associated with those hardware components can be transitioned to lower power states. Moreover, hardware components may have multiple power states at which those hardware components can use during system suspension. For instance, a hardware component may be transitioned to a low power state when this hardware component serves as a wake source. But, when not serving as a wake source, this hardware component may be transitioned to a further low power state (e.g., a fully off state).

Such power state management problems are not isolated to system suspension. By way of example, hardware components may be transitioned to one or more low power states even when processors are currently active, such as in situations in which a phone is placed in airplane mode, thereby requiring certain radios be transitioned to a low power or fully off state.

Different types of systems may have different requirements for power and wake latency, which may dictate power state(s) to which a system can transition. For a given system architecture, one may define a set of standard power states for a system and implement only those power states. However, this may be insufficient to achieve the goal of reaping the best possible power benefits while satisfying resume time latencies of that system. Previous approaches include retrofitting a set of standard power states, but these approaches may not achieve optimal power benefits, and may place restrictions on the system that can impact overall performance. For instance, there may be very few options for narrowly-scoped wakeups with particular device hierarchies, which can limit system operation and adversely impact power management for the system as a whole.

### BRIEF SUMMARY

Battery life of electronic devices (e.g., mobile devices, wearable devices such as smartwatches and head-mounted display, laptop computers, etc.) is a significant factor in device performance and overall user satisfaction. To advance and/or increase battery life, advance and/or increase energy conservation, and/or reduce waste heat, aspects of the disclosed technology provide power savings via managing power states of hardware of electronic devices. By way of example, these power states may represent dependencies between power states and usage models based on those dependencies. By managing these power states, as described herein, power consumption, functionality and/or wake latency of electronic devices may be improved over other approaches. For instance, other approaches use power models and may underestimate actual power consumption of certain user journeys, sometimes by a factor of at least two. Aspects of the disclosed technology include optimizing management of parasitic workloads to improve overall power efficiency of wearable devices, thereby improving device performance. Aspects of the technology include an operating system (OS) serving as a supervisor for another OS.

In accordance with other aspects of the disclosed technology provide methods and systems that put hardware in low power states (e.g., off). The technology may include a power manager that provides support for sequencing of operations to properly power down and/or power up components (e.g., hardware) of a system. The technology also provides support for management (e.g., ownership and/or administration) of policies associated with powering down and/or powering up components of a system. And the technology provides support for a chain of attribution that explains why components of a system are powered up so that performance and/or functional demands are clear. Support may be provided for diagnostics and/or observability of a system by making (e.g., exposing) information related to mechanization of power state transitions (e.g., action of changing power states) available to certain components. A technical benefit of the technology is that it enables granular power management control.

By way of example, the technology can be used for system suspension (e.g., suspend/resume). In suspend/resume, processors (e.g., central processing units (CPUs)) stop executing tasks and are placed into idle states. When processors are in idle states, a number of components (e.g., hardware) of a system are not able to be used in a meaningful manner. The disclosed technology enables powering down multiple components of a system in a short time interval. The technology enables balancing tradeoffs between power and performance. By way of example, the technology can be used for runtime power management. The technology enables components (e.g., hardware) of a system to be selectively powered down by dynamically tolerating increased latency (e.g., decreased performance) involved in powering those components back up when those components are needed.

Other aspects of the technology enable sequencing of operations for properly powering down and/or powering up components (e.g., hardware) of a system. For instance, a Universal Serial Bus (USB) device may be turned on only once its bus is powered. And before a bus can be powered down, devices on that bus should have a chance to save their respective states. A clock may only operate at a given frequency once a voltage rail supplying that clock is at a corresponding (e.g., sufficiently high) voltage. And a video streaming app may start streaming a video only when there is an active network connection.

According to one aspect of the technology, a method includes communicating, by a processor unit of a computing system, a first request for a processor of the computing system to perform an operation associated with a first component of the computing system; communicating, by the first component based on the first request, a second request to transition a power element to a requested power level, the power element being associated with the operation; and determining, by one or more processors of the computing system, whether to transition the power element to the requested power level based on one or more power level dependencies of the power element.

In an example, the computing system may comprise a wearable device.

Alternatively or additionally to the above, the computing system may comprise a mobile device.

Alternatively or additionally to the above, the method may include, responsive to determining not to transition the power element to the requested power level, queuing a message associated with the operation in a kernel of the computing system.

According to another aspect of the technology, a computing system is provided that comprises a first processor, a second processor that is different from the first processor, and a processor unit operatively couples to the first processor and the second processor. The first processor is configured to cause the second processor to be in a low power level, and while the second processor is in the low power level, cause offload of one or more operations associated with the second processor to the processor unit.

In an example, the second processor may be associated with a first operating system (OS) of the computing system, the processor unit may be associated with a second OS of the computing system, and the second OS may be different from the first OS. Here, the first processor may comprise a microcontroller unit (MCU) and the second processor may comprise an application processor (AP). The first processor may be configured to cause the second processor to be in the low power level by being further configured to cause suspension of the first OS.

Alternatively or additionally to the above, memory may be shared by the processor unit and the second processor.

Alternatively or additionally to the above, the computing system may be a wearable device. Here, the wearable device may include a display and the first processor may be configured to, responsive to receipt of a first display update task associated with a notification to be displayed on the display, cause the second processor to transition from the low power level to an active power level, and responsive to receipt of a second display update task that is not associated with a notification to be displayed on the display, cause the processor unit to perform one or more operations associated with the second display update task.

According to another aspect of the technology, a method is provided that comprises determining, by one or more processors of a computing system, whether a power element of the computing system corresponding to an execution state of the computing system is at an inactive power level; responsive to determining that the power element is at the inactive power level, causing, by the one or more processors, a system activity governor (SAG) of the computing system to communicate a suspend request to one or more components of the computing system; determining, by the one or more processors, whether the suspend request is successful; and responsive to determining that the suspend request is unsuccessful: causing, by the one or more processors, the SAG to notify one or more listeners of the suspend request being unsuccessful; determining, by the one or more processors, whether the power element is still at the inactive power level; and responsive to determining that the power element is still at the inactive power level, causing, by the one or more processors, the SAG to log an error corresponding to the suspend request being successful.

In an example, the computing system may comprise a wearable device.

Alternatively or additionally to the above, the computing system may comprise a mobile device.

Alternatively or additionally to the above, determining whether the power element is still at the inactive power level may be responsive to receiving, by the SAG from the one or more listeners, acknowledgment of the notification of the suspend request being unsuccessful.

Alternatively or additionally to the above, the method may include, responsive to determining that the power element is at the inactive power level, causing, by the one or more processors, the SAG to lock the power element at the inactive power level.

Alternatively or additionally to the above, the method may include, responsive to determining that the power element is at another power level higher than the inactive power level: causing, by the one or more processors, the SAG to communicate another suspend request to the one or more components of the computing system; and determining, by the one or more processors, whether the other suspend request is successful.

According to another aspect of the technology, a non-transitory computer readable storage medium is provided that stores one or more instructions configured for execution by a computing system having one or more processors, the one or more instructions for performing a method comprising determining whether a power element of the computing system corresponding to an execution state of the computing system is at an inactive power level; responsive to determining that the power element is at the inactive power level, causing a system activity governor (SAG) of the computing system to communicate a suspend request to one or more components of the computing system; determining whether the suspend request is successful; and responsive to determining that the suspend request is unsuccessful: causing the SAG to notify one or more listeners of the suspend request being unsuccessful; determining whether the power element is still at the inactive power level; and responsive to determining that the power element is still at the inactive power level, causing the SAG to log an error corresponding to the suspend request being successful.

In an example, determining whether the power element is still at the inactive power level may be responsive to receiving, by the SAG from the one or more listeners, acknowledgment of the notification of the suspend request being unsuccessful.

Alternatively or additionally to the above, the method may include, responsive to determining that the power element is at the inactive power level, causing, by the one or more processors, the SAG to lock the power element at the inactive power level.

### BRIEF DESCRIPTION OF THE DRAWINGS

FIGS. 1A-D illustrate example power elements and power levels in accordance with aspects of the technology.

FIGS. 2A-B illustrate example owners of power elements and power levels in accordance with aspects of the technology.

FIG. 3 illustrates example power level dependencies between components in accordance with aspects of the technology.

FIG. 4 illustrates example power level dependencies between power elements in accordance with aspects of the technology.

FIG. 5 illustrates an example power topology in accordance with aspects of the technology.

FIG. 6 illustrates an example power topology in accordance with aspects of the technology.

FIG. 7 illustrates an example power topology in accordance with aspects of the technology.

FIG. 8 illustrates example states of a lease in accordance with aspects of the technology.

FIG. 9 illustrates an example power topology after a lease has been granted by a power broker in accordance with aspects of the technology.

FIGS. 10A-E illustrate example power management in accordance with aspects of the technology.

FIGS. 11A-E illustrate example power management in accordance with aspects of the technology.

FIG. 12 illustrates an example power topology in accordance with aspects of the technology.

FIGS. 13A-F illustrate example lease acquisition in accordance with aspects of the technology.

FIGS. 14A-E illustrate example lease revocation in accordance with aspects of the technology.

FIG. 15 illustrates a power topology in accordance with aspects of the technology.

FIGS. 16A-H illustrate example power management of a power topology of a system in accordance with aspects of the technology.

FIGS. 17A-B illustrates example error power elements in accordance with aspects of the technology.

FIGS. 18A-E illustrate example flows of suspend-to-idle and resume operations in accordance with aspects of the technology.

FIG. 19 illustrates an example execution state power element associated with a system activity governor (SAG) in accordance with aspects of the technology.

FIG. 20 illustrates an example power element having a power level dependency on the execution state power element in accordance with aspects of the technology.

FIG. 21 illustrates an example power element having a power level dependency on the execution state power element in accordance with aspects of the technology.

FIG. 22 illustrates example power elements having dependencies on the execution state power element in accordance with aspects of the technology.

FIG. 23 illustrates an example suspend flow in accordance with aspects of the technology.

FIGS. 24A-E illustrate block diagram representations of example synthetic power states in accordance with aspects of the technology.

FIGS. 25A-B illustrate a system for use with aspects of the technology.

FIG. 26-27 illustrate example methods in accordance with the above discussion.

### DETAILED DESCRIPTION

As discussed in detail herein, power savings may be provided via managing power states of hardware of a device or system. By way of example, these power states may represent dependencies between elements of the device or system, and usage models based on those dependencies. Managing power states may also provide control of parasitic workloads. Power consumption of a device or system may be managed by that device or system. By way of example, a device or system may transition one or more components of that device or system to low power mode(s) (e.g., suspended, standby, sleep, disabled, etc.). A device or system may include a system activity governor (SAG) that manages power levels of components of that system and/or power states of that system. A SAG may be responsible for determining when to transition a device or system from one power level to another power level.

The disclosed technology supports the transitions of various system elements to different states while managing the interdependencies between those states. A power topology model can be used to manage such transitions and interdependencies, even when the interdependencies come from outside of a particular power topology. For instance, a power manager, which is also referred to as a power broker, may be employed to control or otherwise manage power usage by a device or system using a lease, which provides a technical benefit by establishing the reasons for power use and indicates that there is demand for a particular element-level arising from a source outside of the power topology.

Power management capabilities described herein may be centralized into a single component, such as the power topology model, providing the technical benefit of enabling an operating system to make decisions about power levels of components, devices and/or systems for optimizations based on a full system view. To obtain a comprehensive system view, this component may enable upper layers (if present) to provide context based on software or applications running and send requests for system-level power transitions.

Power topologies described herein may maintain information about available power states of one or more devices (e.g., peripherals, system-on-chip (SoC) devices) of a system, latencies of transitions to the power states, and/or a directed acyclic graph (DAG) that represents dependencies from a device's power state, and functionality provided when in that power state, to another device's power state. By way of example, a monitoring component (such as an automated assistant configured to listen for a particular keyword) may not be able to function unless the device's microphone is powered on and listening for audio spoken by a user. If the microphone is muted, operation of the assistant monitoring component can be optimized and its work paused, thereby saving power.

Power topologies described herein may provide a uniform approach for reporting device states and declaring power dependencies for both suspend/resume and runtime power management. This can support a stable, predictable and power-efficient system. Power topologies described herein may increase or maximize usage of parallelism across suspend and resume paths, which can achieve faster suspend and resume times. Power topologies described herein may establish “pull-on” semantics via power level dependencies that explicitly indicate why devices are in high-power states. This provides debuggability and traceability that assists tuning for power and troubleshooting power-related issues in production. The power topologies may provide explicit relationships between upper-level product modes and lower-level device states. This enables a predictable handling of power management flows end-to-end and opportunities for runtime power management. Power topologies described herein may also provide advanced diagnostic capabilities including, but not limited to, playback of device power states during system mode transitions and power diagnostics for drivers and firmware (e.g., microcontroller (MCU) firmware).

Power management as described herein may have knowledge of wake latencies, power level dependencies, and/or processor energy models. This information can enable work scheduling decisions that ensure critical deadlines are met while managing energy costs. A unified processor bandwidth scheduling policy that precisely relates workload performance and energy requirements may be used to support fine-grained, product-customized control over processor performance trade-offs. Deadline driven scheduling may be used to provide precise control over performance vs. energy cost trade-offs for critical workloads with firm deadlines or performance requirements. Adaptive weighted fair scheduling may be used to balance variable performance requirements of a broad range of general-purpose workloads with energy policies of devices or systems in different operational states. Hybrid fair/deadline scheduling may be used to support workloads with a combination of firm and flexible performance requirements and associated energy costs, ensuring baseline performance while adapting to changing system constraints on energy consumption.

Power management as described herein may enable specification of power consumption levels in a standardized way and transition between these power consumption levels as needed. This enables more power-optimal design of device drivers, and enables a power management framework to understand and manage clear dependencies between power states of devices.

Power management as described herein may enable specification of transition latencies from power levels, which enables informed decisions on aggressive power levels to achieve in a given resume latency window. By way of example, during a sleep mode of a system, a maintenance window may be programmatically scheduled for pending tasks to be executed. An interval between each scheduling of the maintenance window may be increased incrementally to conserve power. Other approaches handle each of these lengthening standby intervals the same way because there is no knowledge about when a next wake will occur (resulting in the same power savings each time in sleep mode). In contrast, the technology can provide a time at which the next maintenance window will be scheduled, indicating that the system will have more time to resume. Thus, the technology enables entering a deeper power saving mode, resulting in increased power saving each time in sleep mode.

Other approaches may not provide built-in mechanisms for drivers to share information about their power levels, power level dependencies or transitional latencies. Thus, in other approaches, drivers are responsible for managing their own power consumption, which can lead to problems if drivers do not understand the system's state or the power level dependencies between different devices. For example, if a device has more power levels that the device can enter during runtime idle, the device may not be able to safely enter these power levels without understanding the system's state and the state of its dependencies, which limits the system's ability to achieve its full power efficiency potential and may cause unexpected bugs. Because, in other approaches, a centralized power policy manager in the user space does not know the resume latency of the system, such a centralized power policy manager could only put the system in standard ACPI defined states. This may prevent the system from entering more aggressive power states that would be possible if the system knew the resume latency, for example. In contrast, the disclosed technology enables device-level power levels and transitional latencies to be known and managed by a power management framework, a centralized power policy manager can enter aggressive power states at any given time.

### Power Elements and Power Levels

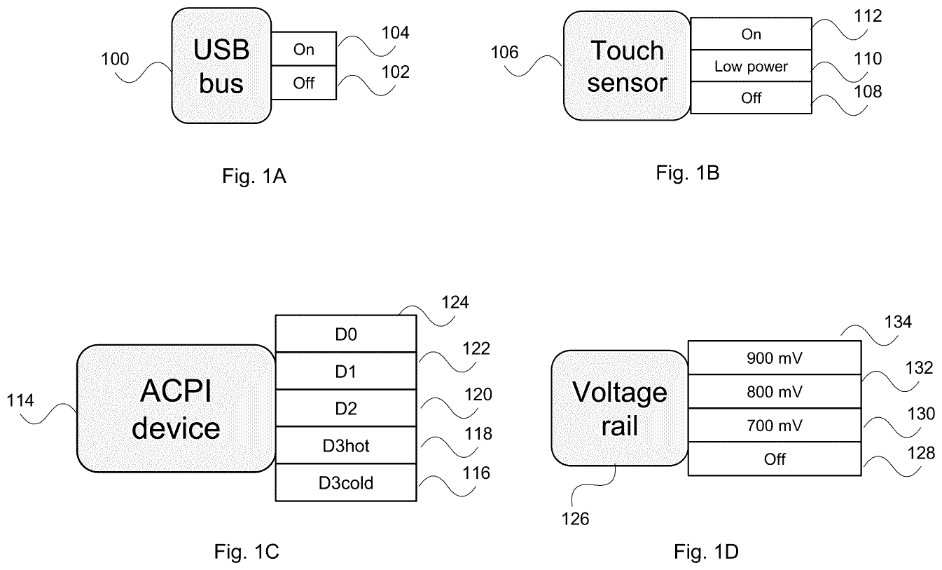

FIGS. 1A-D illustrate example power elements and power levels in accordance with aspects of the technology. As used herein, “power element” refers to a unit of centralized power control. A power element has a finite number of states that it may occupy and, at any given time, a power element occupies exactly one of these states. A power element can represent hardware (e.g., a device), software (e.g., a feature that can be enabled or disabled), or a combination thereof. A given hardware device may correspond directly to a single power element. A given hardware device may correspond to multiple power elements that describe different device states. By way of example, a sample rate and a capacity for position tracking of a touch sensor may be represented by a power element for sample rate, and another power element for position tracking. Power elements can correspond to abstract concepts, such as an overarching state of a subsystem that includes multiple hardware devices and/or enabled or disabled states of user-facing software features.

As used herein, “power levels” refer to different states that a power element can occupy. Power levels may be ordered by increasing power consumption. Power levels may be numerically indexed starting at 0 (e.g., 0, 1, 2, etc.). If power levels for a power element include an off or disabled state, then this state may be indexed at 0. Non-numerical indices may also be employed.

As used herein, “power level schema” refers to a set of power levels that a given power element can occupy, and metadata associated therewith. This metadata can include a respective label for each power level of a given power level schema and/or ordering of power levels of a given schema by increasing power consumption. Power elements of a system may use multiple different power level schemas. By way of example, a power level schema may define a power element that specifies a minimum frequency or clock speed (e.g., operating in the MHz or GHz range) at which a CPU will run and power levels that correspond to supported frequencies for that CPU. However, this power level schema may not be used with, or define, other power elements of a system.

FIG. 1A illustrates power element 100 representing a Universal Serial Bus (USB) bus. The power element 100 has a binary power level schema including off power level 102 and on power level 104 associated therewith. FIG. 1B illustrates power element 106 representing a touch sensor. The power element 106 has a tertiary power level schema including an “off” power level 108, a “low power” power level 110, and an “on” power level 112 associated therewith. FIG. 1C illustrates power element 114 representing an Advanced Configuration and Power Interface (ACPI) device. The power element 114 has a power level schema for ACPI D-states without D0ix, including D3cold power level 116, D3hot power level 118, D2 power level 120, D1 power level 122, and DO power level 124 associated therewith. Note that the power levels 116, 118, 120, 122 and 124 may be ordered in reverse of ACPI convention. FIG. 1D illustrates power element 126 representing a voltage (power) rail. The power element 126 has off power level 128, 700 millivolts (mV) power level 130, 800 mV power level 132, and 900 mV power level 134 associated therewith.

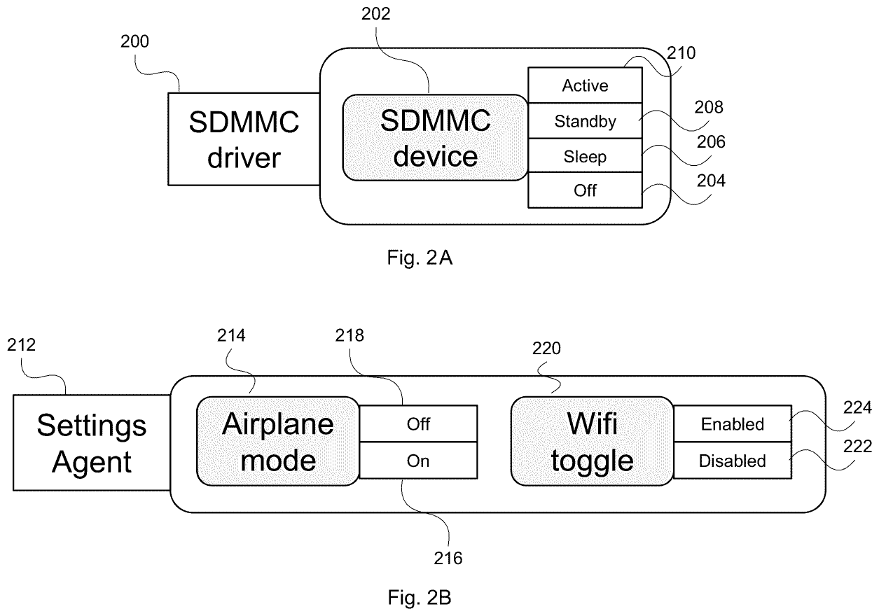

FIGS. 2A-B illustrate example owners of power elements and power levels in accordance with aspects of the technology. An owner of one or more power elements may be a component of a system responsible for managing those power elements. In particular, an owner can be responsible for transitioning its power elements to different power levels. Owners may be drivers or other modules corresponding to hardware elements associated with the power elements. FIG. 2A illustrates a Secure Digital and MultiMediaCard (SDMMC) driver 200 that is the owner of power element 202 representing an SDMMC device. The power element 202 has “off” power level 204, “sleep” power level 206, “standby” power level 208, and “active” power level 210 associated therewith. FIG. 2B illustrates a settings agent 212 that is the owner of power element 214 representing an airplane mode feature and power element 220 representing a WiFi toggle feature. The power element 214 has “off” power level 216 and “on” power level 218 associated therewith. The power element 220 has “disabled” power level 222 and “enabled” power level 224 associated therewith.

An owner of a power element may be a framework for writing drivers, such as driver framework version two (DFv2). The power framework disclosed herein does not distinguish between driver and non-driver components.

In some scenarios, a power element may function correctly at a subset of its power levels. The subset of power levels of a power element may be referred to as operable power levels of that power element. The operable power levels of a power element may be based on current system conditions, for example. The operable power levels include power levels less than or equal to a maximum operable power level, which may be denoted as max_operable_level(E) for a power element E.

As used herein, a “power level dependency” refers to a relationship between two or more power elements. A power level dependency is a condition indicating how the operable power levels of one power element are related to the power levels (e.g., current power level (current_level)) of another power element. A power level dependency can indicate that in order for a child power element C to operate at or above power level L, a parent power element P has to operate at least a required power level RL. By way of example, a power level dependency of (C, L) on (P, RL) can be expressed as if current_level(P)<RL, then max_operable_level(C)<L. Equivalently, this power level dependency of (C, L) on (P, RL) can be expressed as max_operable_level(C)≥L only if current_level(P)≥RL. Each power level dependency of (C, L) establishes a condition in order for power level L to be included with the operable power level. A power level dependency may be considered as “satisfied”, “fulfilled”, etc. based on the state of that power level dependency's associated condition.

For a power level K<power level L, each dependency of (C, K) is a condition for the operability of power level L. In particular, the operability of (C, L) may place a requirement on a parent power element even though (C, L) itself does not depend directly on that power element. A set of power elements with such requirements can be referred to as required power elements (required_elements) of (C, L). For the parent power element P, there is a minimum required power level for (C, L) to be operable, which may be denoted as min_required_level(P; C, L).

Aggregating over all required elements, the following collection of necessary conditions must be satisfied for L to be operable: current_level(P)≥min_required_level(P; C, L) for all P E required_elements(C, L). If these conditions are satisfied, then power level L may be referred to as nominally operable. However, power level L may not be operable even if it is nominally operable. By way of example, local conditions, such as hardware errors (e.g., unobserved hardware errors), may prevent child power element C from operating at power level L even if all relevant power level dependencies have been satisfied.

A power element may have multiple power level dependencies on another power element. A set of such power level dependencies for a particular parent and child can be referred to as a power element dependency. A child power element C depends on parent power element P if there is a dependency from at least one power level of child power element C to at least one power level of parent power element P.

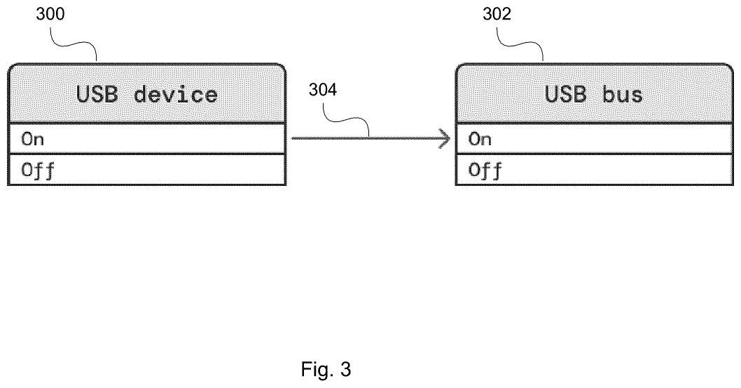

FIG. 3 illustrates an example of power level dependencies between components in accordance with aspects of the technology. An example of a power level dependency is one that relates on/off states of one component to on/off states of another component. FIG. 3 illustrates a USB device 300 having an on state and an off state, and a USB bus 302 having an on state and an off state. Arrow 304 represents a power level dependency of the USB device 300 on the USB bus 302: the USB bus 302 must be in the on state in order for the USB device 300 to be in the on state. To handle this dependency in an orderly way, the USB bus 302 must be in the on state (e.g., powered on) before the USB device 300 is put in the on state (e.g., powered on). Similarly, the USB device 300 must be in the off state (e.g., powered down) before the USB bus 302 is put in the off state (e.g., powered down).

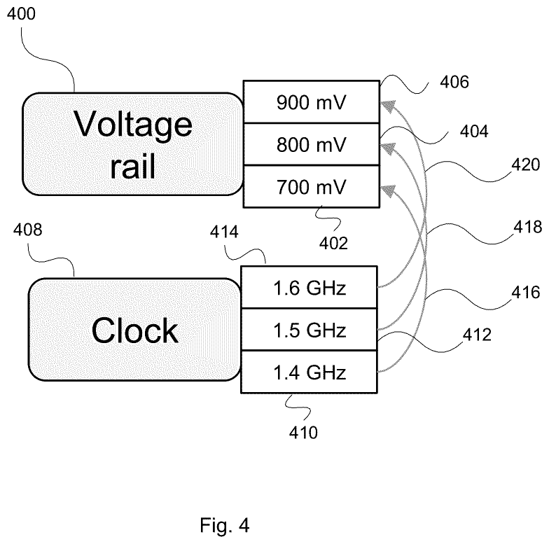

FIG. 4 illustrates example power level dependencies between power elements in accordance with aspects of the technology. Here, power element 400 represents a voltage rail. The power element 400 has 700 mV power level 402, 800 mV power level 404, and 900 mV power level 406 associated therewith. Power element 408 represents a clock. The power element 408 has 1.4 gigahertz (GHz) power level 410, 1.5 GHz power level 412, and 1.6 GHz power level 414 associated therewith.

The arrows 416, 418 and 420 represent power dependencies between the power element 400 and the power element 408. Here, the power element 408 is a child of the power element 400. The arrow 416 represents the power dependency between the power level 410 (the clock operating at 1.4 GHz) and the power level 402 (the voltage rail being at 700 mV). As indicated by the direction of the arrow 416, in order for the clock to operate at 1.4 GHz, the voltage rail has to be at least 700 mV. Thus, in order for the power element 408 to be at the power level 410, the power element 400 has to be at the power level 402 or higher (e.g., the power level 404, the power level 406). As indicated by the direction of the arrow 418, in order for the clock to operate at 1.5 GHZ, the voltage rail has to be at least 800 mV. Thus, in order for the power element 408 to be at the power level 412, the power element 400 has to be at the power level 404 or higher (e.g., the power level 406). As indicated by the direction of the arrow 420, in order for the clock to operate at 1.6 GHz, the voltage rail has to be at least 900 mV. Thus, in order for the power element 408 to be at the power level 414, the power element 400 has to be at the power level 406.

### Power Topologies

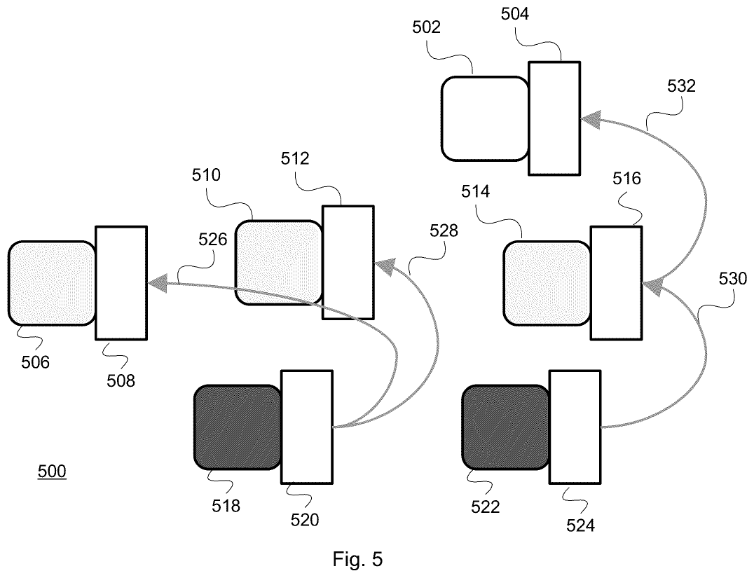

FIG. 5 illustrates an example power topology 500 in accordance with aspects of the technology. A power topology is a multi-edged graph with power elements as nodes of that graph, and power level dependencies as directed edges of that graph. A power topology may be acyclic. In particular, if a child power element C depends on parent power element P, then parent power element P may not depend on child power element C.

In the power topology or preferred implementations, the minimum power level of a power element must always be operable, regardless of current power levels of other power elements. The minimum power level of a power element may have no power level dependencies. This condition refers to operability rather than nominal operability, and ensures that each power element has at least one operable power level. This condition may be enforced by the owner of the power element. Although permitting a minimum power level of a power element to depend on another a minimum power level of another power element would have no impact on operability, such dependencies would be functionally irrelevant. Also, permitting such dependencies would require consideration of power elements that are interdependent only via their minimum power levels.

A power topology may include redundant power level dependencies. For example, power level L of power element C may depend on both required power level RL1 and required power level 2 of power element P, where required power level RL1 is less or lower than required power level RL2. Redundant power level dependencies are harmless in a power topology. However, as described herein, in some cases, redundant power level dependencies may receive special consideration.

As shown in FIG. 5, the power topology 500 includes power elements 502, 506, 510, 514, 518 and 522 having power levels 504, 508, 512, 516, 520 and 524, respectively. Arrows 526, 528, 530 and 532 represent power level dependencies of the power topology 500. The arrow 526 represents that at least one of the power levels 520 of the power element 518 depends on at least one of the power levels 508 of the power element 506. The arrow 528 represents that at least one of the power levels 520 of the power element 518 depends on at least one of the power levels 512 of the power element 510. Thus, a change in the power levels 520 of the power element 518 may require changes in both the power levels 508 of the power element 506 and the power levels 512 of the power element 510.

The arrow 530 represents that at least one of the power levels 524 of the power element 522 depends on at least one of the power levels 516 of the power element 514. The arrow 532 represents that at least one of the power levels 516 of the power element 514 depends on at least one of the power levels 504 of the power element 502. Thus, a change in the power levels 524 of the power element 522 may require changes in the power levels 516 of the power element 514, which, in turn, may require changes in the power levels 504 of the power element 502.

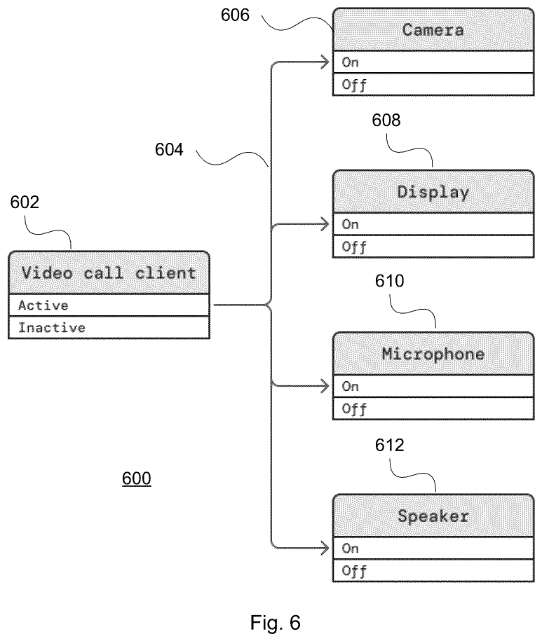

FIG. 6 illustrates an example power topology 600 in accordance with aspects of the technology. Power elements that represent software features or user-level operational modes of a device may have multiple (e.g., 2, 3, 4, or more) power level dependencies to capture resources that those power elements need in order to function properly. By way of example, power topology 600 includes a power element 602 that represents a video call client having an “active” power level and an “inactive” power level. As illustrated by arrow 604, the “active” power level of the power element 602 depends on power elements representing other components or subsystems of a device in order to conduct a video call: a camera represented by power element 606, a display represented by power element 608, a microphone represented by power element 610, and a speaker represented by power element 612. In order for the power element 602 to be put at the “active” power level, each of the power elements 606, 608, 610 and 612 have to be at their respective “on” power levels.

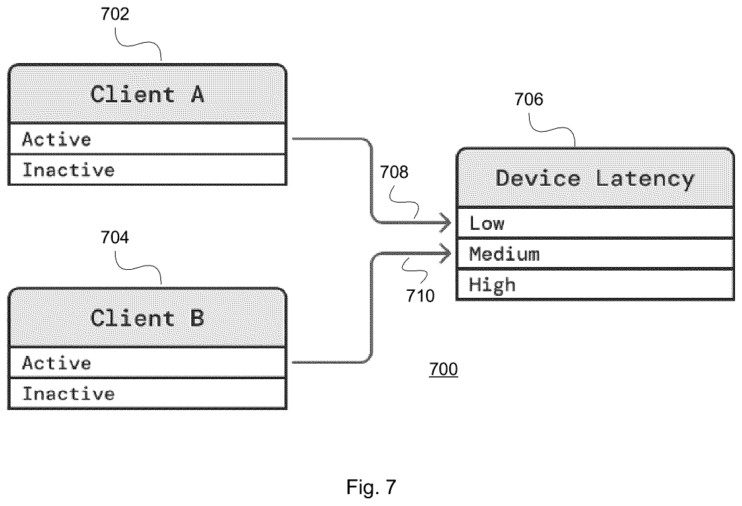

FIG. 7 illustrates an example power topology 700 in accordance with aspects of the technology. Multiple child power elements may depend on the same parent power element. Power levels may be defined such that the needs of different clients cannot conflict. By way of example, power topology 700 includes a device having power levels described in terms of latency. Power element 702 represents Client A, power element 704 represents client B, and power element 706 represents latency of the device. Each of the power elements 702 and 704 have an “active” power level and an “inactive” power level. The power element 706 has a “low latency” power level, a “medium latency” power level, and a “high latency” power level. As indicated by arrow 708, the active power level of the power element 702 depends on the low latency power level of the power element 706. As indicated by arrow 710, the active power level of the power element 704 depends on the medium latency power level of the power element 706. Thus, if the power element 702 is at the active power level, then the power element 706 must be at the low latency power level irrespective of whether the power element 704 is at the active power level or not. The power level dependencies of both the power elements 702 and 704 are satisfied when the power element 706 is at the low latency power level.

### Power Broker

A power broker may be a subsystem (e.g., a module) responsible for tracking and managing power interdependencies and component requests to use powered components (e.g., devices, system entities). A power broker may maintain the minimum power equilibrium of a device or system. The minimum power equilibrium refers to each power element of a power topology being at its respective minimum power level necessary to satisfy the current operational needs of the device or system.

A power broker maintains a power topology and uses that power topology to determine which power elements to direct to change (e.g., increase, decrease) their respective power levels in order to maintain the minimum power equilibrium. Owners of power elements may register their power elements and power level dependencies of those power elements with the power broker. For security purposes, permissions to modify power level dependencies of a power element may be restricted through access tokens.

A power broker may be configured to use a control scheme to provide a balance between demand for power usage and constraints that inhibit power usage. Demand for power use by various components of a device may arise from or be based on functional requirements of that device. These functional requirements may vary over time. For example, as a user's expectations of a device changes, the functional requirements of that device may change accordingly. For instance, a user may open an application or activate a feature for a specific task indicating that power levels of certain power elements associated with that application or feature need to be changed (e.g., elevated). By way of example, a device may sense activity indicative of a user being near that device and that the user is likely to interact with that device suggesting that the device should be ready to respond with low latency (e.g., enter a low latency mode). By way of example, demand for power usage of a device may occur even when an application or processor of that device is inactive based on ways a user may interact with that device to wake the device (e.g., speaking a “hot” keyword, clicking a mouse, tapping a screen, etc.).

A power broker (power manager) controls and/or manages power usage by a device or system using a lease. A lease is a grant by a power broker for a power element to have power level dependencies of that power element satisfied so that power element can be at a particular power level. A lease may be indicative of demand for a particular power level of a particular power element arising from a source outside of a power topology (e.g., external to a system or device). A lease identifies one or more claims, each claim identifying a power level dependency that must be satisfied in service of that lease. To request a change (e.g., raise) in a power level of a power element, a component (e.g., an owner) with permission to lease that power element requests a lease (also referred to as a lease request). This component may retain the lease (e.g., in a resource acquisition is initialization (RAII) manner) until the power level can be lowered. Control parameters may be communicated from a component to a power broker and vice versa. By way of example, these control parameters may indicate a power element to be leased, a requested power level for that power element to be leased, states or statuses of a lease, and/or states (e.g., current power levels) of a power element.

A power broker enables a power topology to be centrally administered. Administrating a power topology in a distributed manner or peer-to-peer may have increased likelihood of implementation errors in dependency management. However, as a centralized administrator, the power broker has systemwide visibility to maintain the minimum power equilibrium of a device or system. As a central administrator, a power broker has authority to perform attribution (e.g., know and/or determine which component(s) or subsystem(s) are responsible for power usage). As a central administrator, a power broker can maintain and report detailed telemetry, even if an individual component (e.g., subsystem) provides no instrumentation. Central administration by a power broker removes agency from owners of power elements that should not have it. By way of example, it may be preferred that drivers do not make decisions regarding power levels of their underlying hardware. Such a preference can be explicitly encoded by a driver by forfeiting the capability of that driver to satisfy lease for a power element owned by that driver.

Centralized administration via a power broker may introduce some local performance costs because the power broker introduces a party to be made aware of power elements and their power levels. However, from a global perspective, the power broker provides opportunities for systemwide performance optimization, which may offset, if not overcome, local performance costs.

In some scenarios, inserting a power broker into a control flow between power elements and components that own those power elements may introduce some latency. However, in other scenarios, inserting a power broker may actually reduce latency because the power broker's knowledge of power topology enables orderly power-up and/or power-down operations to skip directly to the top or bottom of a chain of power level dependencies when initiating.

Power level dependencies may be active or passive. Both active and passive power level dependencies prevent raising of a power level of a dependent power element until power levels of one or more required power elements on which the dependent power element depends are at required power levels. For a lease request with one or more active power level dependencies, a power broker instructs owners of one or more required power elements to raise their power levels in order to satisfy the dependency (and any transitive active dependencies of the required elements).

For a lease request with one or more passive power level dependencies, in order for a passive power level dependency to be satisfied, power levels of required power elements are raised by another mechanism than for active power level dependencies. For example, for passive power level dependencies, power levels of required power elements may be raised via another lease with an active dependency on required power elements. For passive power level dependencies, required power elements may be limiter power elements that independently raise their power levels. Thus, an active power level dependency on a power element that has a passive power level dependency on another power element will not cause power level of that other power element, or any elements on which that other power element has active dependencies, to increase. However, a passive power level dependency temporarily prevents lowering a power level of a required power element in an orderly power-down operation (e.g., a different lease with an active power level dependency on the required power element that raised the power level of the required power element is dropped) until the dependent power element has powered down.

An active claim for an active power level dependency may raise a power level of a required power element. However, a passive claim for a passive power level dependency may not.

There are different types of power elements. Managed power elements refer to power elements whose owners defer determination of changes to power levels and the timing of those changes to a power broker. In other words, the power levels of a managed power element are wholly managed by the power broker (with the exception of error states) is a managed power element. At all times, the power broker communicates to a managed power element which power level to maintain (e.g., required power level). Deviations from a required power level should be transitory or error scenarios. Managed power elements may be managed according to a minimum power level policy: a power broker communicates, to each power element owner, a respective minimum power level for each owned power element so that outstanding and requested leases are satisfied.

Unmanaged power elements are power elements that are not managed by the power broker. Unmanaged power elements describe states that are not software controlled and/or can only be observed, such as the state of a hardware switch or the error state of a piece of hardware, for example. An unmanaged power element does not have power level dependencies. The owner of an unmanaged power element reports the current power level of that unmanaged power element to the power broker if there is a change in power levels of that unmanaged power element. However, the current power level of an unmanaged power element affects operability of other power elements that depend on that unmanaged power element. Unmanaged power elements may describe states that are not software controlled and can only be observed such as, for example, a state of a hardware switch or an error state of a hardware component.

Limiter power elements are not managed by a power broker, but are inputs to a system or device. Limiter power elements represent power elements outside control of the power broker, system or policy limitations. Limiter power elements may make decisions to raise or lower their power levels independently. That is, power levels of limiter power elements cannot be leased. Thus, dependent power elements cannot cause changes to power levels of limiter power elements. However, limiter power elements inform the power broker of their current power levels. Limiter power elements inform the power broker of active limitations to a power topology. Other power elements may have passive power level dependencies on power levels of limiter power elements.

A current power level of a limiter power element may cause the power broker to reject lease requests if there is a passive dependency on that limiter power element that is higher than the current power level of that limiter power element. A limiter power element may initiate an orderly power down operation by providing forewarning of an impending lowering of its current power level. In response, the power broker drives dependent power elements to lower power levels such that dependencies are unbroken. A limiter power element may initiate a disorderly power down operation by the owner of that limiter power element notifying the power broker that that limiter power element is already at a lower power level, thereby breaking dependencies.

An “orderly” power down operation may include the power broker instructing dependent power elements to lower their respective power levels before any power elements(e.g., a power element associated with those dependent power elements) lower their power levels. An orderly power down operation may ensure that power level dependencies are maintained throughout power level transitions associated with the power down operation. An orderly power down operation is a controlled and sequenced process, which may reduce system-level unpredictability.

A “disorderly” power down operation may include a power element lowering its power level before receiving instructions from the power broker to do so. By way of example, a power element may lower its power level before the power broker instructs one or more dependent power elements associated with that power element to lower their power levels. A disorderly power down operation may break power level dependencies abruptly. A disorderly power down operation, unlike an orderly power down operation, is an uncontrolled, and potentially reactive, process, which may be triggered by external events and/or unmanaged power elements.

Consumer power elements are not actively managed by a power broker. However, the power broker may manage power elements on which consumer power elements depend. Other power elements do not depend on consumer power elements. Consumer power elements represent active user or system needs that drive power usage by a system or device.

Consumer power elements represent user, system and/or functional needs for power resources in a system or device. Consumer power elements may initiate and/or drive power-up operations. Owners of consumer power elements may request, from the power broker, leases on power levels of their consumer power elements. In response to a lease request from an owner of a consumer power element, the power broker determines whether that lease can be satisfied based on dependencies of that consumer power element for the requested power level and limitations on the power topology from any limiter power elements. If the lease can be satisfied, then the power broker will begin performing power-up operations in order to satisfy the dependencies (direct and transitive) of that lease (see, e.g., video call client example described in FIG. 6).

Consumer power elements may initiate and/or drive (orderly) power-down operations by dropping leases. Dropping leases causes the power broker to release claims on power elements on which those consumer power elements depend.

A power topology might not have a 1:1 ratio of power elements to drivers of a system or device. A single driver may be the owner of multiple power elements. Power elements may be defined based on functionality that can be enabled or disabled by hardware of the system or device. By way of example, if a driver has two different functions that can be independently enabled, in order to make this functionality available through a power broker, then these functions are defined as two separate power elements. However, if a driver has two different functions that are linked such that these functions can only be enabled or disabled together, then these functions are defined as a single power element or two power elements but with those two power elements depending on another power element.

A policy agent may be used to translate between an interface between hardware provided by a driver and power levels used by a power broker and power topology. A power broker can inform policy agents to which power levels to set their respective devices. In response, the policy agent configures or toggles associated settings through the driver to set the devices to those power levels.

For an owner of a consumer power element to raise a power level of its consumer power element, the owner makes a lease request to a power broker for a lease on that power level. If the requested increase is feasible, then the power broker responds to the owner with a pending lease. The power broker then attempts to transition its managed power elements to respective power levels necessary to satisfy this lease (required power levels). To do so, the power broker generates a series of claims, a claim being a requirement that a single particular dependency be satisfied in service of a lease. The series of claims is in a sequence to maintain dependencies between each power element in a chain of power elements corresponding to the series of claims. There may be a 1:1 ratio of claims to power level dependencies of a power topology.

One or more factors may determine a steady state of managed power elements. A steady state can be the power levels to which a power broker instructs the managed power elements for a particular set of factors (e.g., the factors remain unchanged). Non-limiting examples of factors that determine a steady state include a power topology (e.g., power elements and power level dependencies), leases, and current power levels of unmanaged power elements. Changes to one or more of these factors may lead to a re-evaluation of the steady state.

A factor in determining a steady state is evaluating which leases can be granted (e.g., all power level dependencies of the leased power element and power level can be satisfied). A power broker may handle leases in an all-or-nothing fashion. If there is a lease on a particular element and power level but the power broker cannot (e.g., the power broker is unable to satisfy one or more power level dependencies because the owner(s) associated with those power level dependencies deny instructions to make corresponding power level changes) or will not (e.g., the power broker will not instruct power element(s) associated with one or more power level dependencies to change their power levels (e.g., because maintaining a steady state)) satisfy all power level dependencies for that lease, then the power broker does not attempt to satisfy any of those power level dependencies, unless doing so contributes to a different lease that can be granted.

To determine whether a lease can be granted, a power broker determines both whether the power broker “can” grant the lease and whether the power broker “should” grant the lease. Whether the power broker “can” grant a lease is a matter of functional requirements and is addressed by the current power levels of unmanaged power elements. Whether the power broker “should” grant a lease is a matter of whether or not the power broker attempts to satisfy a power level dependency on a managed power element.

For instance, whether the power broker “should” grant a lease can be based on one or more fulfillment policies for power level dependencies, such as a strong fulfillment policy and a weak fulfillment policy. A power level dependency may be strongly-fulfilled only if the associated power element is managed. A power level dependency may be weakly-fulfilled if the associated power element is managed or unmanaged. Fulfillment policies may aggregate to paths of power level dependencies. A path of power level dependencies is strongly-fulfilled if every power level dependency in that path is strongly-fulfilled. Otherwise, that path of power level dependencies is weakly-fulfilled. The following are a few examples of fulfillment policies.

For a weakly-fulfilled path of power level dependencies, if the respective current power levels of all unmanaged power elements on which a leased power element and power level depends are the respective required power levels or higher than the respective required power levels, then the lease may be granted.

For a weakly-fulfilled path of power level dependencies, if the respective current power levels of all managed power elements on which a leased power element and power level depends are at the respective required power levels or higher than the respective required power levels, then the lease may be granted.

If parent element P is unmanaged, then current_level(P)≥RL. If parent element P is managed, then (P, RL) is required by another lease that is fulfilled in the steady state and depends on it via a strongly-fulfilled path.

Once steady-state fulfillment of leases is determined, the steady state power level of any managed element C is simply the largest level required by a fulfilled lease, or min_level(C) if no fulfilled lease requires one of C's levels.

A power broker may direct a system or device towards a steady state by performing operations in dependency order. If the steady state power levels of all power elements of a system or device are higher than or equal to current power levels, then direction of the system or device towards the steady state is orderly. In some scenarios, disorderly changes may occur when power levels are lowered. Termination policies for power level dependencies may be orderly-on-termination or disorderly-on-termination. A power level dependency on a managed power element is orderly-on-termination. A power level dependency on an unmanaged power element is disorderly-on-termination. Termination policies aggregate to paths of power level dependencies. If all power level dependencies in a path of power level dependencies are managed, then that path of power level dependencies is orderly-on-termination. Otherwise, that path of power level dependencies is disorderly-on-termination. If a power level of a given power element depends on a given power level of a managed power element via an orderly-on-termination path, then a power broker will instruct that the current power level of the given power element be lowered before the current power level of the managed power element is lowered below that given power level.

For a disorderly-on-termination dependency of a power level of a given power element that depends on a given power level of an unmanaged power element, if the current power level of the unmanaged power element is lowered below the given power level, this event is beyond the control of a power broker. There is not an opportunity for the power broker to drive the power level of the given power element lower in advance. Rather, the power broker drives the power level of the given power element lower reactively. Because transitive power level dependencies on the given power level of the unmanaged power element are also broken as soon as the current power level of the unmanaged power element is lowered, there is no clear ordering of power level changes to impose as a system or device is driven to a new steady state.

A power level dependency that is weakly-fulfilled and disorderly-on-termination may be referred to as a basic power level dependency. A power level dependency that is weakly-fulfilled and orderly-on-termination may be referred to as an opportunistic power level dependency. A power level dependency that is strongly-fulfilled and orderly-on-termination may be referred to as an assertive power level dependency. A basic power level dependency is always a managed power element dependent on an unmanaged power element, whereas both an assertive power level dependency and an opportunistic power level dependency are always a managed power element dependent on another managed power element.

### Lease States

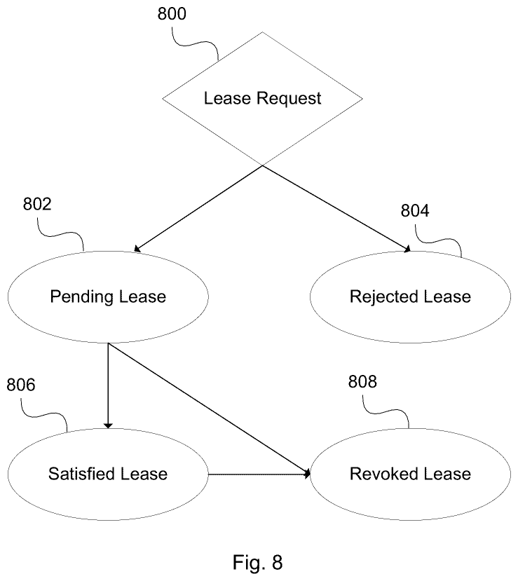

FIG. 8 illustrates example states of a lease in accordance with aspects of the technology. For a given lease request 800, a power broker may respond with a rejected lease 804 because the power broker has determined that a system or device cannot or will not be able to satisfy the power level change of the lease request 800 (e.g., because of unsatisfied passive dependencies). However, for the given lease request 800, the power broker may respond with a pending lease 802 because the power broker has determined that a system or device can satisfy the power level change of the lease request 800. A lease is pending while the power broker and the system perform power-up operations to satisfy all dependencies (e.g., direct, transitive) of the power level of the lease request 800. A pending lease 802 may transition to a revoked lease 808 in response to the power broker and/or the system no longer attempting to perform power-up operations to satisfy all dependencies (e.g., direct, transitive) of the power level of the lease request 800. By way of example, a hardware error may occur during one or more power-up operations. Alternatively, the pending lease 802 may transition to a satisfied lease 806 (also referred to as an active lease) after all dependencies for the power level of the lease request 800 are satisfied. A satisfied (or active) lease 806 may be revoked by the power broker (e.g., the revoked lease 808) if there is a subsequent change to a power level of another power element (e.g., an orderly or disorderly power-down) that results in the system or device no longer being able to maintain the power level of the satisfied lease 806.

Leases provide for attribution in a system or device. For each power element that is in a non-minimal state, a series of claims of a lease represents a chain of reasons that specify a functional system or user need that the system or device is performing. This information (e.g., power trace logs) can be provided by a power broker in real-time or in a post-hoc summary, which may be used for automated or manual analysis. These power trace logs are a powerful tool for detecting and reducing unnecessary power consumption in a system or device.

The power broker can be responsible for communicating to each driver and/or component of a system or device which power level to maintain. As described above, the power broker's primary operating policy may be a minimum power level policy. The power broker may attempt to maintain minimum power levels for each power element to satisfy outstanding leases (e.g., maximum power levels across all valid claims on a power element) by communicating to components and/or drivers to power-down and/or lower their performance states when those components and/or drivers are not needed. Thus, all uses of power elements in a system or device may have a chain of attribution associated with their power levels, or be powered down (e.g., off). When a lease is no longer needed, that lease may be dropped (revoked). As a result, claims of that lease are dropped and the power levels of the power elements on which that lease depends (assuming there are no other dependent elements) being lowered in an orderly manner such that the power level dependencies of each of those power elements are maintained throughout transitioning those power elements to lower power levels.

By way of example, if there are no leases held on a Wi-Fi radio power element, the power broker instructs the owner of that Wi-Fi radio power element to transition to an “off” power level. For illustrative purposes, assume that the Wi-Fi radio of a system shares a power rail with other components of the system, such as a Bluetooth radio. This requirement can be modeled as both a Bluetooth radio power element and the Wi-Fi radio power element each having a power level dependency for their respective “on” power levels for an “on” power level of a power rail power element. Thus, if the system is using either the Bluetooth radio or the Wi-Fi radio, then the power rail would need to remain on. If the system is not using either the Bluetooth radio or the Wi-Fi radio, then the power broker would instruct the owner of the power rail power element to remain at an “off” power level until the power rail is needed. In other words, the power broker will not instruct the owner of the power rail power element to raise to the on power level unless the power rail is needed (here, for either or both radio devices).

A power broker provides protocols for components and power elements to retrieve expected and historical latencies associated with power level transitions. These protocols may be subject to access controls as described herein with respect to protocols. Because the power broker tracks all power level transitions by power elements of a system or device, latency metrics for power level transitions of each power element are available. Non-limiting examples of latency metrics include an amount of time to power on and/or power off a core CPU, an amount of time to power on and/or power off all secondary CPUs, amount of time to power on a microphone and start collecting data, and/or an amount of time to put memory into and/or out of a self-refresh mode. These latency metrics may supplement driver-provided latency data. The power broker may also provide latency data and driver-provided latency data may be used to seed the power broker's initial latency estimates. This data may, for example, inform decisions about when power elements should power-up or power-down, notify power elements of when their dependencies are expected to become available, and/or predictively signal state transitions.

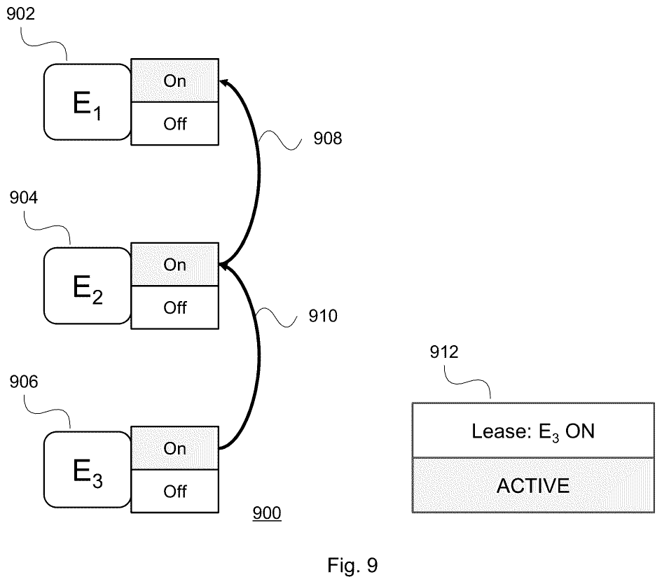

FIG. 9 illustrates an example power topology 900 after a lease has been granted by a power broker in accordance with aspects of the technology. The power topology 900 includes power element E₁ 902, power element E₂ 904, and power element E₃ 906. Each of the power element E₁ 902, the power element E₂ 904, and the power element E₃ 906 have a respective “on” power level and a respective “off” power level. As indicated by arrow 908, the on power level of power element E₂ 904 depends on the on power level of power element E₁ 902. As indicated by arrow 910, the on power level of power element E₃ 906 depends on the on power level of power element E₂ 904.

The lease 912 is for the power element E₃ 906 to be at the on power level. The lease 912 is active. In order for the power element E₃ 906 to be at the on power level, the power element E₂ 904 needs to be at the on power level. In order for the power element E₂ 904 to be at the on power level, the power element E₁ 902 needs to be at the on power level. Thus, the power broker instructs the owner of the power element E₁ 902 to put the power element E₁ 902 at the on power level. If, for some reason, a power element (e.g., the power element E₁ 902) cannot raise its power level as instructed (e.g., the required power level is not operable (e.g., a hardware error is discovered during the attempt to raise the power level)), the power broker may take an action to make that power level for that power element no longer nominally operable. For example, an error state element may be used to specify the inoperability of that power level for that power element.

In response to the owner of the power element E₁ 902 informing the power broker that the power element E₁ 902 is at the on power level, the power broker instructs the owner of the power element E₂ 904 to put the power element E₂ 904 at the on power level. In response to the owner of the power element E₂ 904 informing the power broker that the power element E₂ 904 is at the on power level, the power broker instructs the owner of the power element E₃ 906 to put the power element E₃ 906 at the on power level. In response to the owner of the power element E₃ 906 informing the power broker that the power element E₃ 906 is at the on power level, the power broker then indicates that the lease 912 is active.

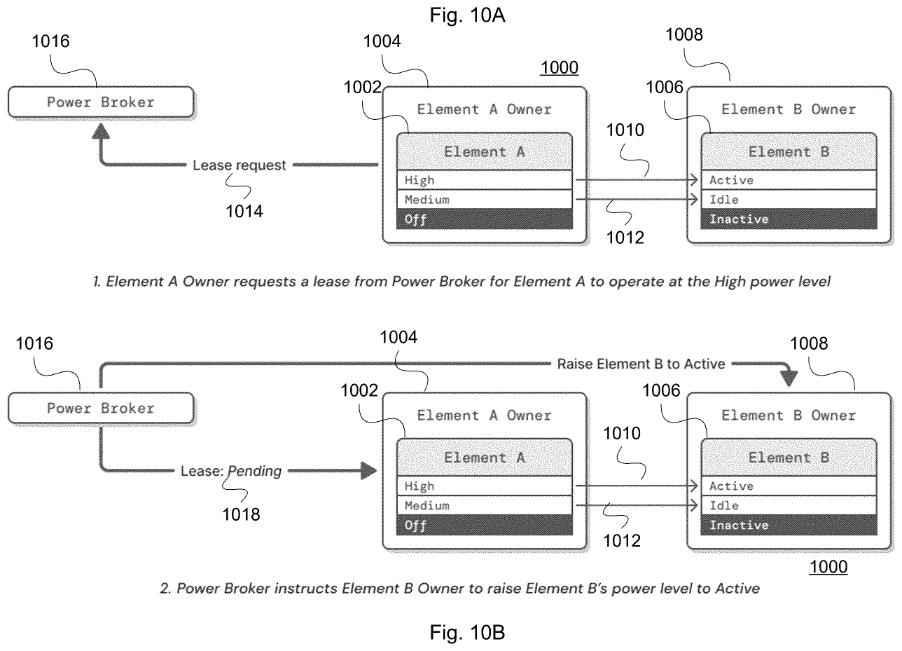

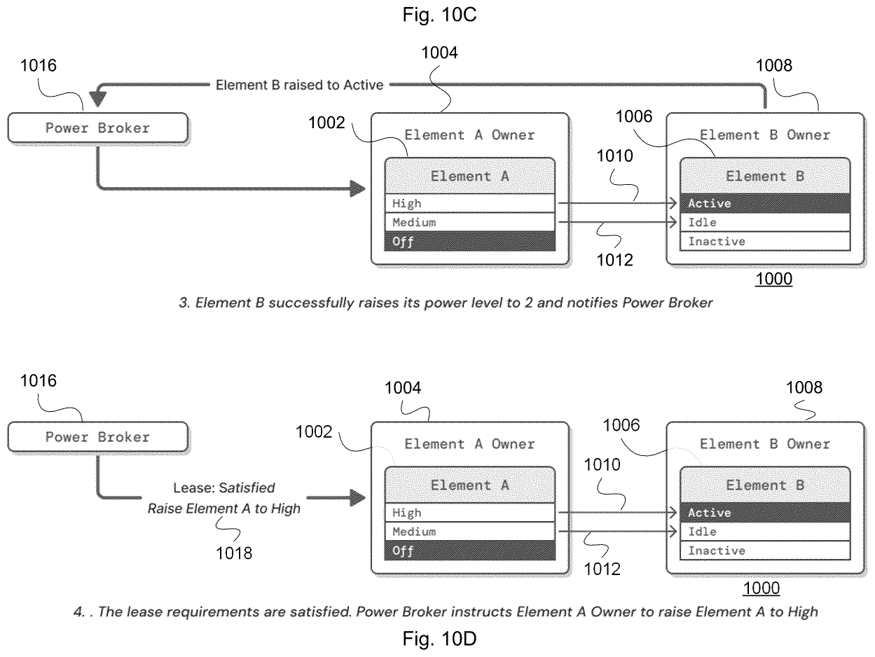

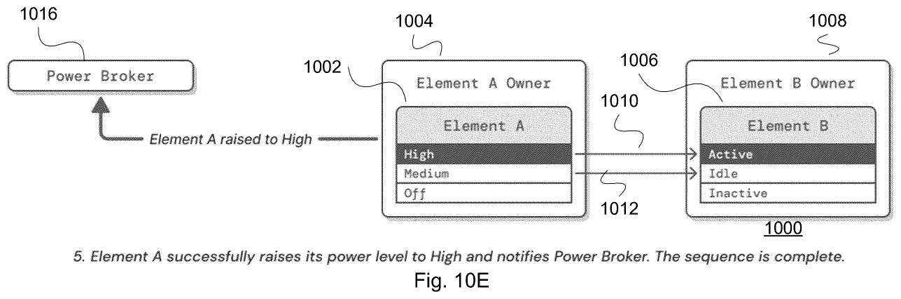

FIGS. 10A-E illustrate example power management in accordance with aspects of the technology. FIG. 10A illustrates power topology 1000, which includes power element A 1002 and power element B 1006. The power element A 1002 has three power levels: “high”, “medium” and “off”. The power element A 1002 is owned by power element A owner 1004. The power element B 1006 has three power levels: “active”, “idle” and “inactive”. The power element B 1006 is owned by power element B owner 1008. As indicated by arrow 1010, the high power level of the power element A 1002 depends on the active power level of the power element B 1006. As indicated by arrow 1012, the medium power level of the power element A 1002 depends on the idle power level of the power element B 1006.

In FIG. 10A, the current power level of the power element A 1002 is the off power level (indicated by the shading) and the current power level of the power element B 1006 is the inactive power level(indicated by the shading). The power element A owner 1004 communicates a lease request 1014 to a power broker 1016. The lease request 1014 is for the power element A 1002 to operate at the high power level.

In FIG. 10B, the power broker 1016 communicates to the power element A owner 1004 that a lease 1018 is pending. For example, as noted above, the lease may be pending while the power broker and the system perform power-up operations to satisfy all dependencies) of the power level of the lease request. In this example, the power broker 1016 instructs the power element B owner 1008 to raise the power level of the power element B 1006 to the active power level. This is because the high power level of the power element A 1002 depends on the active power level of the power element B 1006.

In FIG. 10C, the power element B owner 1008 communicates to the power broker 1016 that the power level of the power element B 1006 has been raised to the active power level. The current power level of the power element B 1006 is now the active power level(indicated by the shading). In FIG. 10D, the power broker 1016 communicates to the power element A owner 1004 that the lease 1018 is satisfied and instructs the power element A owner 1004 to raise the power level of the power element A 1002 to the high power level. And in FIG. 10E, the power element A owner 1004 communicates to the power broker 1016 that the power level of the power element A 1002 has been raised to the high power level. The current power level of the power element A 1002 is now the high power level(indicated by the shading). The lease 1018 is now granted.

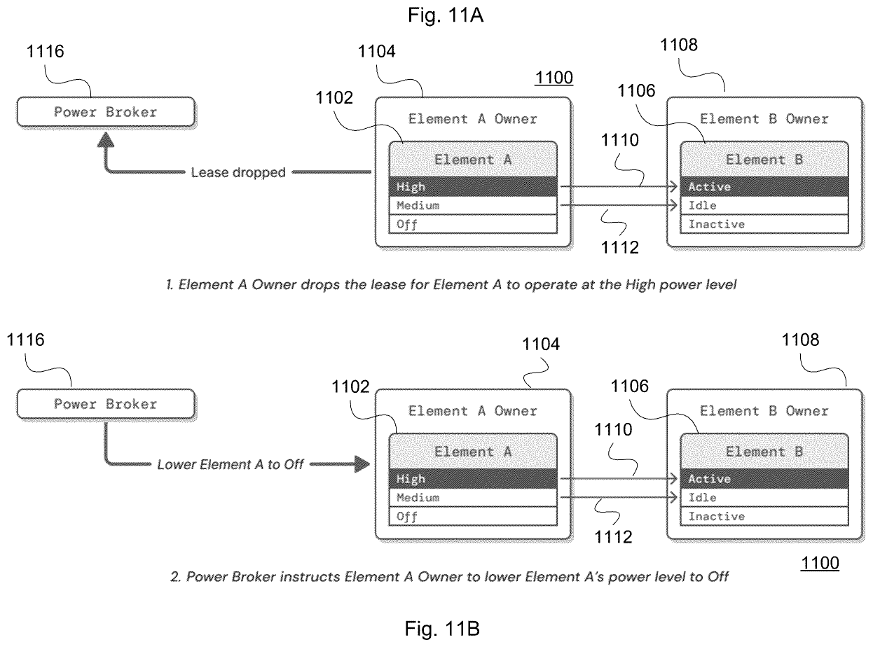

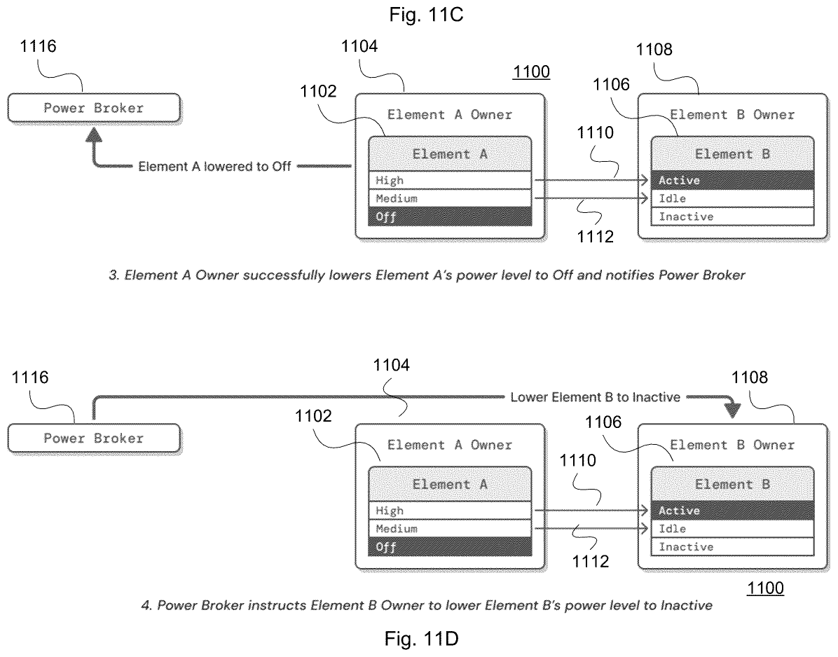

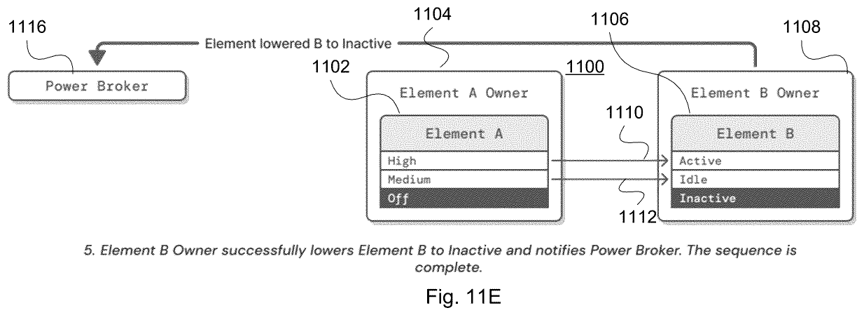

FIGS. 11A-E illustrate example power management in accordance with aspects of the technology. FIG. 11A illustrates power topology 1100, which includes power element A 1102 and power element B 1106. The power element A 1102 has three power levels: “high”, “medium” and “off”. The power element A 1102 is owned by power element A owner 1104. The power element B 1106 has three power levels: “active”, “idle” and “inactive”. The power element B 1106 is owned by power element B owner 1108. As indicated by arrow 1110, the high power level of the power element A 1102 depends on the active power level of the power element B 1106. As indicated by arrow 1112, the medium power level of the power element A 1102 depends on the idle power level of the power element B 1106.

In FIG. 11A, the current power level of the power element A 1102 is the high power level(indicated by the shading) and the current power level of the power element B 1106 is the active power level(indicated by the shading). The power element A owner 1104 communicates to a power broker 1116 that it is dropping a lease for operating the power element A 1102 at the high power level(e.g., the lease 1118 described in association with FIGS. 11A-E). The lease is now revoked by the power broker 1116. In FIG. 11B, the power broker 1116 instructs the power element A owner 1104 to lower the power level of the power element A 1102 to the off power level. In FIG. 11C, the power element A owner 1104 communicates to the power broker 1116 that the power level of the power element A 1102 has been lowered to the off power level. The current power level of the power element A 1102 is now the off power level(indicated by the shading).

In FIG. 11D, the power broker 1116 instructs the power element B owner 1108 to lower the power level of the power element B 1106 to the inactive power level. This is because the high power level of the power element A 1102 depends on the active power level of the power element B 1106. With the power element A 1102 no longer operating at the high power level, the power element B 1106 no longer needs to operate at the active power level. In FIG. 11E, the power element A owner 1104 communicates to the power broker 1116 that the power level of the power element 1102 has been lowered to the inactive power level. The current power level of the power element B 1102 is now the inactive power level(indicated by the shading).

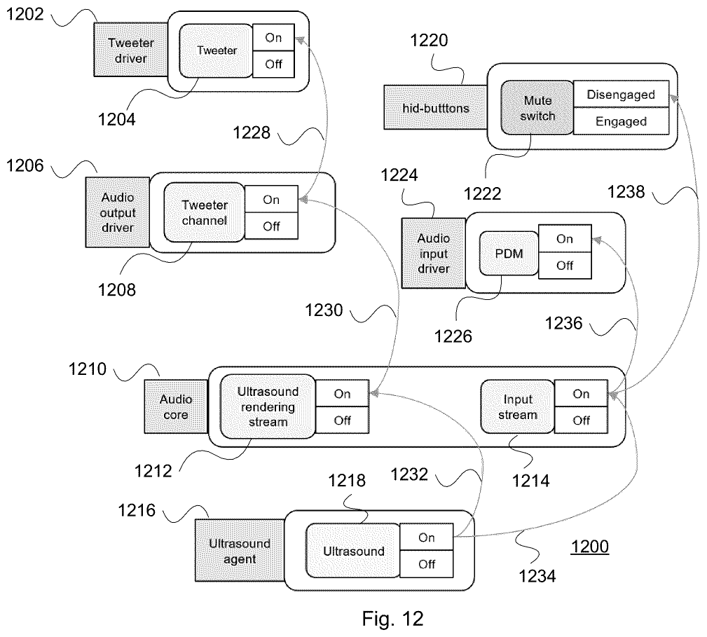

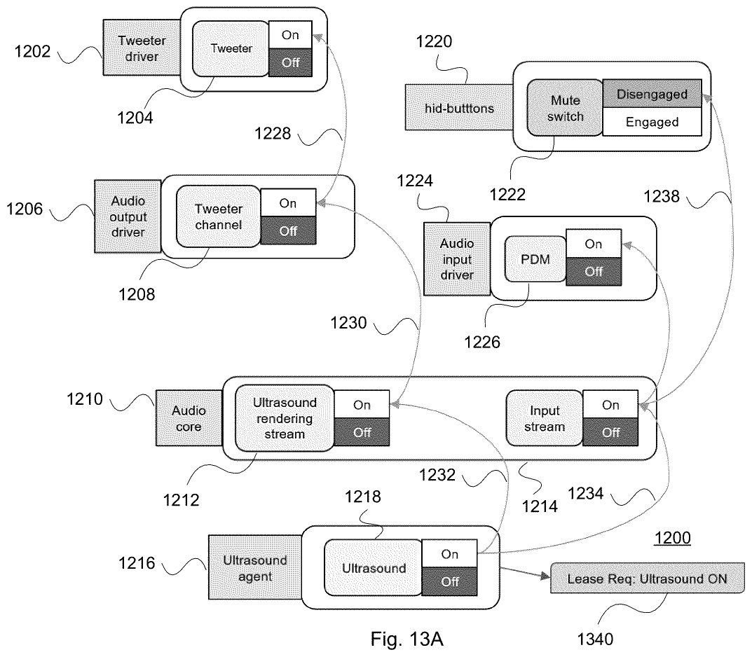

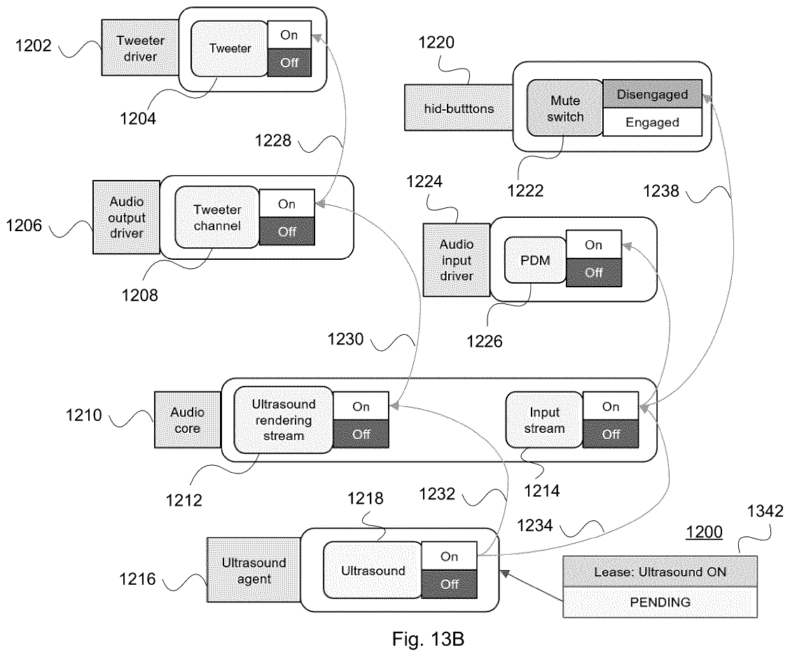

FIG. 12 illustrates an example power topology 1200 in accordance with aspects of the technology. The power topology 1200 is associated with smart display audio of a system (e.g., an entertainment system). The power topology 1200 includes a power element 1204 representing a tweeter of the system. The power element 1204 is owned by a tweeter driver 1202 of the system. The power element 1204 has an “on” power level and an “off” power level. The power element 1204 is a managed power element.

The power topology 1200 includes a power element 1208 representing a tweeter channel of the system. The power element 1208 is owned by an audio output driver 1206 of the system. The power element 1206 has an “on” power level and an “off” power level. The power element 1206 is a managed power element.

The power topology 1200 includes a power element 1212 representing an ultrasound rendering stream of the system and a power element 1214 representing an input stream of the system. The power elements 1212 and 1214 are owned by an audio core 1210 of the system. The power elements 1212 and 1214 each have an “on” power level and an “off” power level. The power elements 1212 and 1214 are managed power elements.

The power topology 1200 includes a power element 1226 representing pulse-density modulation (PDM) of the system. The power element 1226 is owned by an audio input driver 1224 of the system. The power element 1224 has an “on” power level and an “off” power level. The power element 1224 is a managed power element.

The power topology 1200 includes a power element 1218 representing an ultrasound component of the system. The power element 1218 is owned by an ultrasound agent 1216 of the system. The power element 1218 has an “on” power level and an “off” power level. The power element 1218 is a consumer power element. The ultrasound component drives power consumption of the system based on a user's needs.

The power topology 1200 includes a power element 1222 representing a mute switch of the system. The power element 1222 is owned by a human interface device (HID) buttons driver (“hid-buttons”) 1220 of the system. The power element 1222 has a “disengaged” power level and an “engaged” power level. The power element 1222 is a limiter power element. When the mute switch is engaged, the input stream is forced off.

As indicated by arrows 1232 and 1234, the on power level of the power element 1218 depends on the on power level of the power element 1212 and the on power level of the power element 1214. As indicated by arrow 1230, the on power level of the power element 1212 depends on the on power level of the power element 1208. As indicated by arrow 1228, the on power level of the power element 1208 depends on the on power level of the power element 1204. As indicated by arrows 1236 and 1238, the on power level of the power element 1214 depends on the on power level of the power element 1226 and the on power level of the power element 1222.

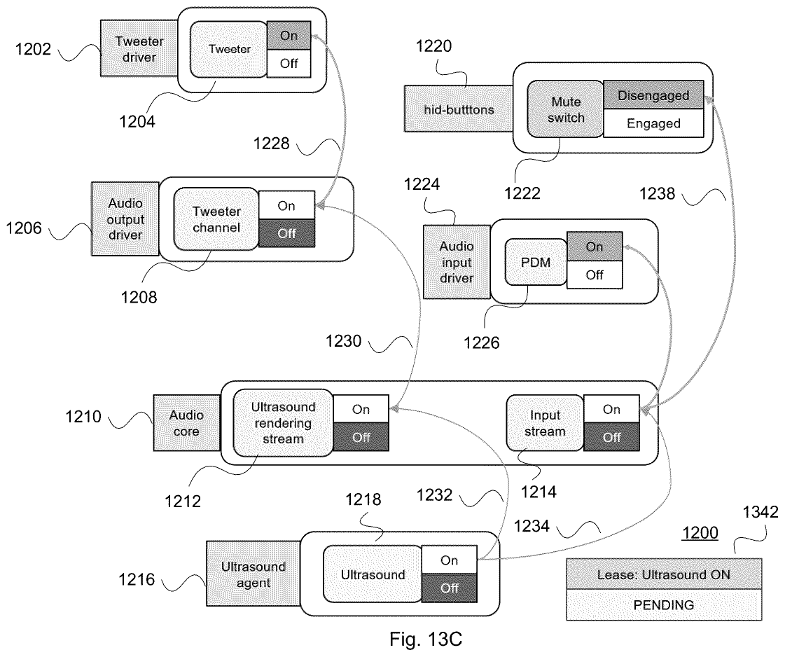

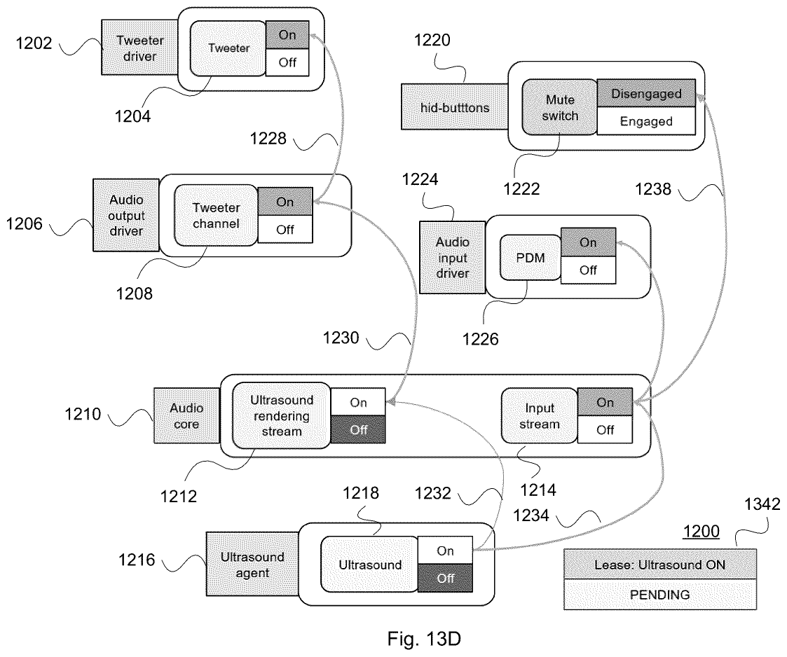

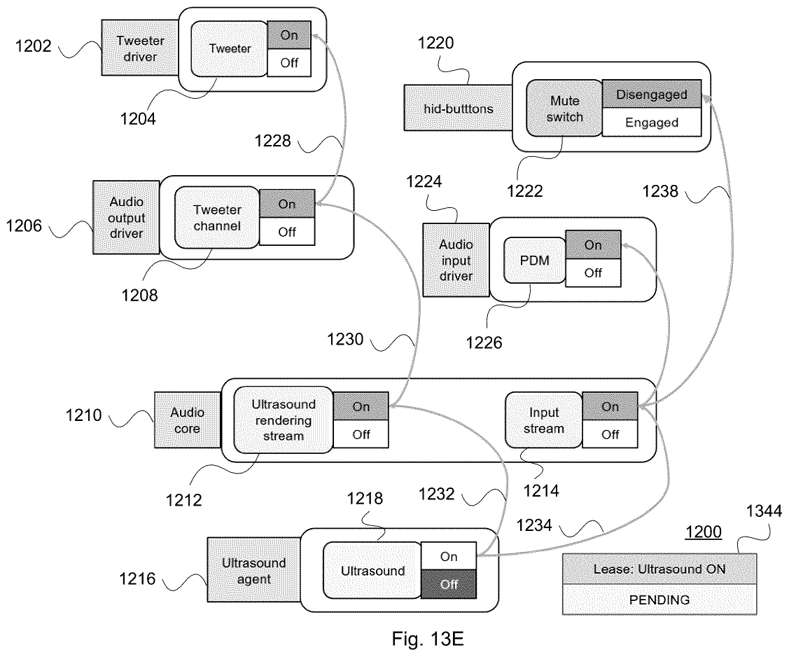

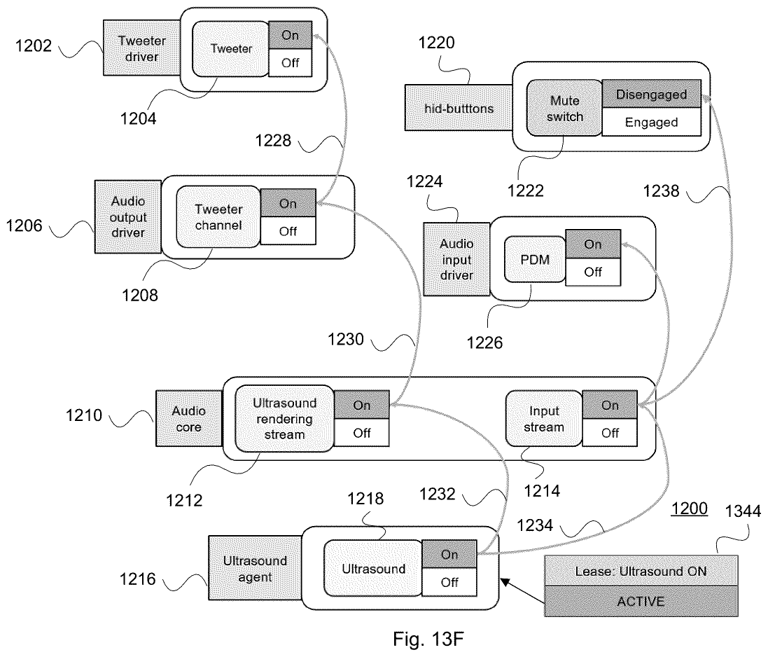

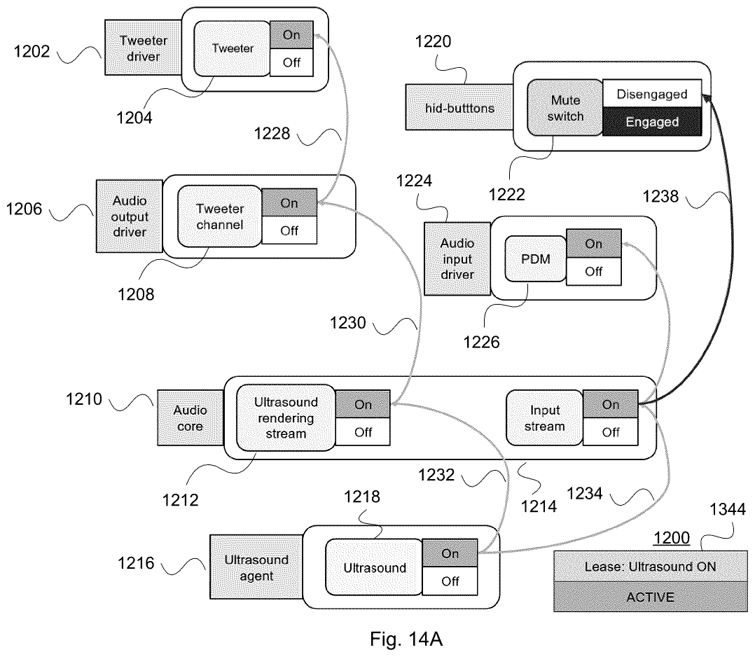

FIGS. 13A-F illustrate example lease acquisition in accordance with aspects of the technology. The example lease acquisition is for the power topology 1200, which is described in association with FIG. 12. In FIG. 13A, the current power levels of the power elements 1204, 1208, 1212, 1214, 1218 and 1226 are the off power level. The current power level of the power element 1222 is the disengaged power level(indicated by the shading). The ultrasound agent 1216 communicates, to a power broker of the system, a lease request 1340 for the power element 1218 to operate at the on power level(indicated by the shading).

In FIG. 13B, the power broker determines whether all dependencies of the on power level of the power element 1218 can be satisfied. By way of example, the power broker may traverse the power topology 1200 to determine whether all dependencies of the on power level of the power element 1218 can be satisfied. Here, the dependencies of the on power level of the power element 1218 can be satisfied. Thus, the power broker communicates, to the ultrasound agent 1216, a pending lease 1342.

In FIG. 13C, the power broker issues instructions to the tweeter driver 1202 to raise the power level of the power element 1204 to its required power level to satisfy the pending lease 1242: the on power level. Thus, the current power level of the power element 1204 is the on power level(indicated by the shading). The tweeter driver 1202 communicates to the power broker that the current power level of the power element 1204 is the on power level.

The power broker issues instructions to the audio input driver 1224 to raise the power level of the power element 1226 to its required power level to satisfy the pending lease 1342: the on power level. Thus, the current power level of the power element 1226 is the on power level (indicated by the shading). The audio input driver 1224 communicates to the power broker that the current power level of the power element 1226 is the on power level.

The power broker issues instructions to the HID buttons driver 1220 to raise the power level of the power element 1222 to its required power level to satisfy the pending lease 1342: the disengaged power level. However, the current power level of the power element 1222 already is the disengaged power level(indicated by the shading). The HID buttons driver 1220 communicates to the power broker that the current power level of the power element 1222 is the disengaged power level.

The power broker may instruct the tweeter driver 1202, the HID buttons driver 1220 and the audio input driver 1224, in any order. However, the power elements 1204, 1222 and 1226 have to be at the respective required power levels before the power broker addresses other power level dependencies for the pending lease 1342.

In response to notification of the current power levels of the power elements 1204, 1222 and 1226 being the respective required power levels, in FIG. 13D, the power broker now addresses the power elements 1208 and 1214. The power broker issues instructions to the audio output driver 1206 to raise the power level of the power element 1208 to its required power level to satisfy the pending lease 1342: the on power level. Thus, the current power level of the power element 1208 is the on power level(indicated by the shading). The audio output driver 1206 communicates to the power broker that the current power level of the power element 1208 is the on power level.

The power broker issues instructions to the audio core 1210 to raise the power level of the power element 1214 to its required power level to satisfy the pending lease 1342: the on power level. Thus, the current power level of the power element 1214 is the on power level(indicated by the shading). The audio core 1210 communicates to the power broker that the current power level of the power element 1214 is the on power level.

The power broker may instruct the audio output driver 1206 and the audio core 1210 in any order. However, the power elements 1208 and 1214 have to be at the on power level before the power broker addresses the power level of the power elements 1212 and 1218 for the pending lease 1342.

In response to notification of the current power levels of the power elements 1208 and 1214 being the respective required power levels, in FIG. 13E, the power broker now addresses the power element 1212. The power broker issues instructions to the audio core 1210 to raise the power level of the power element 1212 to its required power level to satisfy the pending lease 1342: the on power level. Thus, the current power level of the power element 1212 is the on power level(indicated by the shading). The audio core 1210 communicates to the power broker that the current power level of the power element 1212 is the on power level.

In response to the current power level of the power element 1212 being the on power level, in FIG. 13F, the ultrasound agent 1216 raises the power level of the power element 1218 to the on power level. Thus, the current power level of the power element 1218 is the on power level (indicated by the shading). The ultrasound agent 1216 communicates to the power broker that the current power level of the power element 1218 is the on power level. Accordingly, all the power level dependencies for the pending lease 1342 have been satisfied and the power broker grants an active lease 1344.

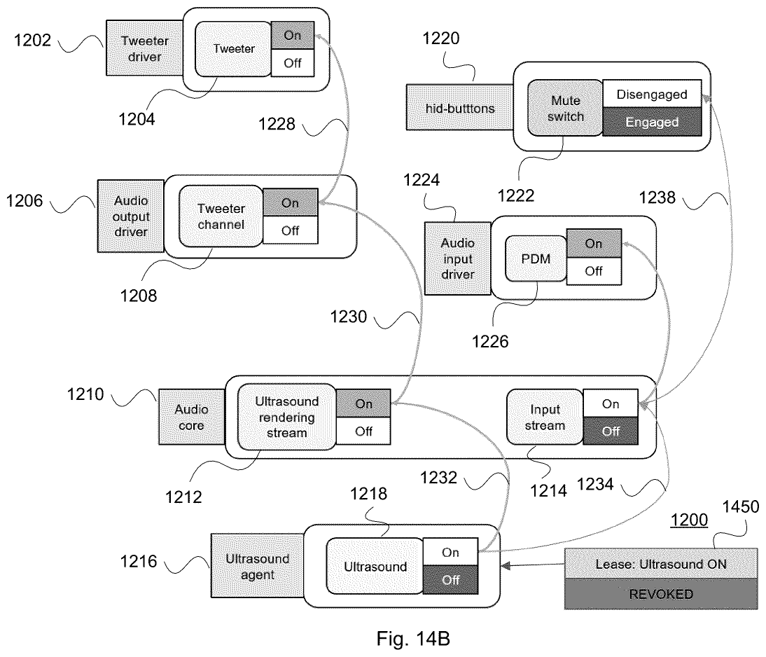

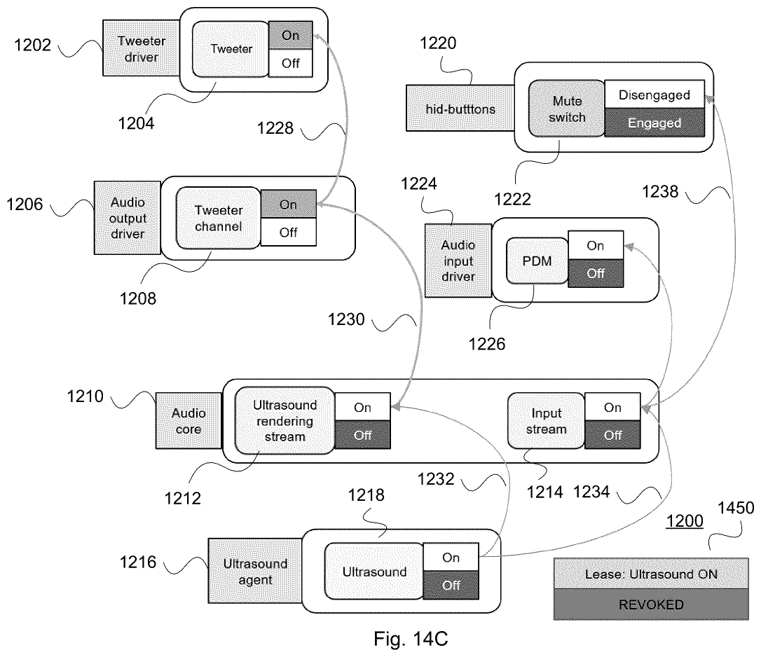

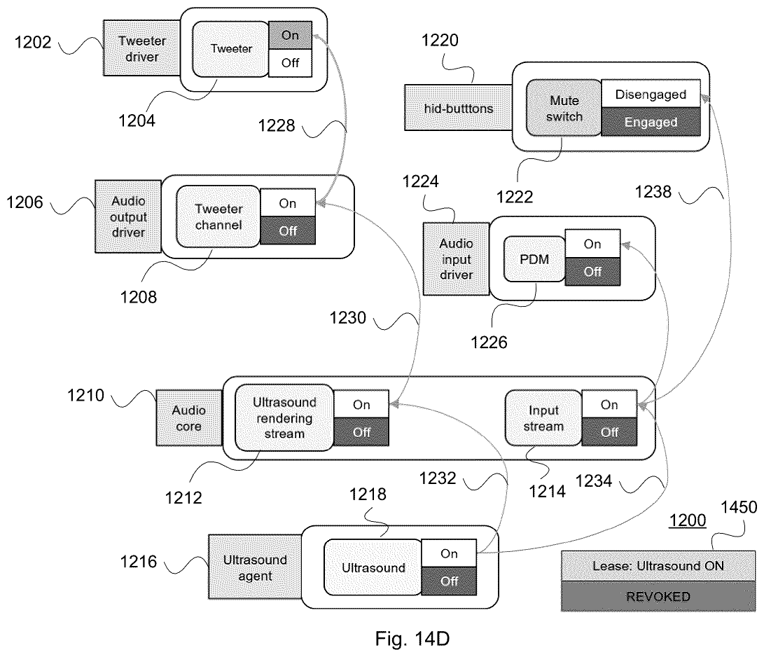

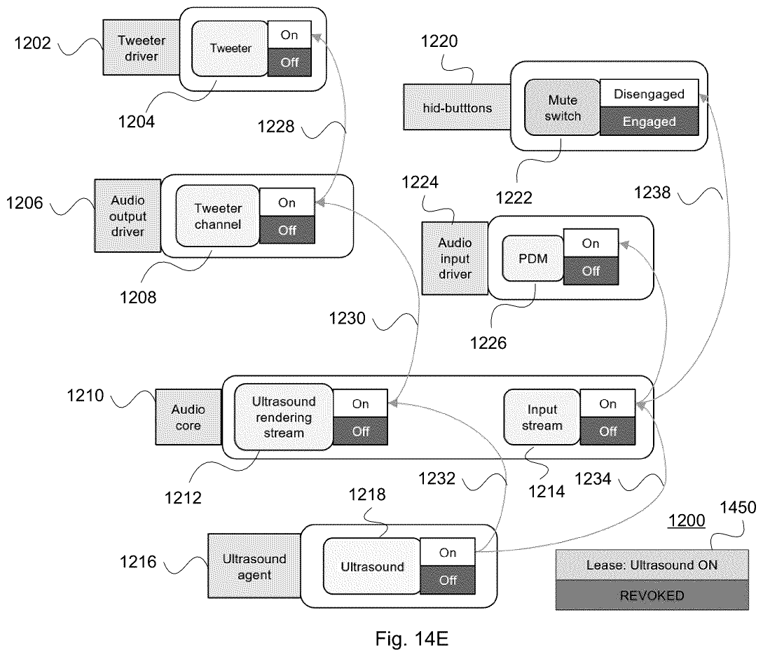

FIGS. 14A-E illustrate an example lease revocation in accordance with aspects of the technology. The example lease revocation is for the power topology 1200, which is described in association with FIG. 12.

In FIG. 14A, the current power levels of the power elements 1204, 1208, 1212, 1214, 1218 and 1226 are the on power level following the acquisition of the active lease 1344 as described in association with FIGS. 13A-F. However, the current power level of the power element 1222 is the engaged power level(indicated by the shading). As a result, the HID buttons driver 1220 communicates, to the power broker, a disorderly power-down. When the mute switch is engaged (i.e., the power element 1222 is at the engaged power level), the microphone's clock may be pinned such that the signal from the microphone is not used.

In FIG. 14B, the power broker revokes the active lease 1344 (revoked lease 1450) notifies owners of power elements dependent on the power element 1222, in particular the disengaged power level. In response to the revoked lease 1450, the ultrasound agent 1216 lowers the power level of the power element 1218 to the off power level. Thus, the current power level of the power element 1218 is the off power level(indicated by the shading). The ultrasound agent 1216 communicates to the power broker that the current power level of the power element 1218 is the off power level.

The power broker issues instructions to the audio core 1210 to lower the power level of the power element 1214 to the off power level. Thus, the current power level of the power element 1214 is the off power level(indicated by the shading). The audio core 1210 communicates to the power broker that the current power level of the power element 1214 is the off power level.

In response to notification of the current power level of the power element 1218 being lowered, in FIG. 14C, the power broker now addresses the power element 1212. The power broker issues instructions to the audio core 1210 to lower the power level of the power element 1212 to the off power level. Thus, the current power level of the power element 1212 is the off power level(indicated by the shading). The audio core 1210 communicates to the power broker that the current power level of the power element 1212 is the off power level.

In response to notification of the current power level of the power element 1214 being lowered, in FIG. 14C, the power broker issues instructions to the audio input driver 1224 to lower the power level of the power element 1226 to the off power level. Thus, the current power level of the power element 1226 is the off power level(indicated by the shading). The audio input driver 1224 communicates to the power broker that the current power level of the power element 1226 is the off power level.

In response to notification of the current power level of the power element 1214 being lowered, in FIG. 14D, the power broker issues instructions to the audio output driver 1206 to lower the power level of the power element 1208 to the off power level. Thus, the current power level of the power element 1208 is the off power level(indicated by the shading). The audio output driver 1206 communicates to the power broker that the current power levels of the power element 1208 is the off power level.

In response to notification of the current power level of the power element 1214 being lowered, in FIG. 14E, the power broker issues instructions to the tweeter driver 1202 to lower the power level of the power element 1204. Thus, the current power level of the power element 1204 is the off power level(indicated by the shading). The tweeter driver 1202 communicates to the power broker that the current power level of the power element 1204 is the off power level.

### Power Broker Operations and Protocols

A power broker may be responsible for maintaining an internal model of a power topology and driving all power elements to the minimum power equilibrium. A topology protocol is an initial protocol used by power element owners to communicate with the power broker. Power element owners may add power elements that they own to the power topology through AddElement. Further interactions of power element owners with the power broker are through channels opened by the AddElement call, which are scoped to the added power element(s). Channels opened by AddElement allow power element owners to further interact with the added power element(s) through ElementControl, Lessor, and LevelControl protocols, which are further described below. If the power broker detects that a power element owner has crashed or otherwise terminated operating the power element, due to element_control_channel, lessor, and level_control_channel all being closed, the power broker may remove that power element from the power topology, along with direct active and passive dependencies of that power element. However, dependencies may require that power elements are not to be removed and are considered permanently unsatisfied (owners of dependent elements may replace or remove these dependencies).

The following illustrates example pseudocode:

```
  @discoverable
open protocol Topology {
  /// Called by a Power Element owner to register a new Power Element and
  /// open control channels for that element.
flexible AddElement(resource struct {
  /// Human-readable name for logging and debug purposes.
  element_name string: 1024;
  /// The list of PowerLevels supported by this element. The lowest level
  /// will be used as the default level for this element.
  supported_levels vector<PowerLevel>:MAX_SUPPORTED_LEVELS;
  /// List of dependencies for this element's power levels.
  /// Note: dependencies UPON this element's levels cannot be added here.
  dependencies
vector<LevelDependency>:MAX_DEPENDENCIES_IN_ADD_ELEMENT;
  /// List of active dependency tokens to register for this element.
  /// These tokens will allow other element owners to create active
  /// dependencies upon this element by passing them as the
  /// requires_token of a LevelDependency.
  active_dependency_tokens_to_register
vector<DependencyToken>:MAX_TOKENS_IN_ADD_ELEMENT;
  /// List of passive dependency tokens to register for this element.
  /// These tokens will allow other element owners to create passive
  /// dependencies upon this element by passing them as the
  /// requires_token of a LevelDependency.
  passive_dependency_tokens_to_register
vector<DependencyToken>:MAX_TOKENS_IN_ADD_ELEMENT;
  }) -> (resource struct {
  /// ElementControl channel for this element.
  element_control_channel client_end:ElementControl;
  /// Lessor channel for this element.
  lessor_channel client_end:Lessor;
  /// LevelControl channel for this element.
  level_control_channel client_end:LevelControl;
  }) error AddElementError;
};
// Limitations on vector length for the sake of bounding request size.
const MAX_SUPPORTED_LEVELS uint16 = 256;
const MAX_DEPENDENCIES_IN_ADD_ELEMENT uint16 = 128;
const MAX_TOKENS_IN_ADD_ELEMENT uint16 = 128;
```

ElementControl provides element-scoped access to an element previously added via Topology.AddElement. The following is example pseudocode:

```
open protocol ElementControl {
  /// Register a new Status channel on which Power Broker will send
  /// read-only updates of the element's current power level. This method
/// is intended to allow element owners to give read-only access to the
/// element's current power level to clients by opening and transferring
/// this channel.
OpenStatusChannel(resource struct {
  status_channel server_end:Status;
});
/// Called by a Power Element owner to remove their Power Element.
/// Removing a Power Element also removes dependencies on other elements,
/// but dependencies on this element will remain permanently unsatisfied.
/// Element, lessor, level control channels and open status channels will be
/// closed and all tokens registered to this element will be unregistered.
flexible RemoveElement() -> ();
/// Adds an active or passive dependency of this element upon another
/// element.
flexible AddDependency(LevelDependency) -> () error ModifyDependencyError;
/// Removes an active or passive dependency of this element upon another
/// element.
flexible RemoveDependency(LevelDependency) -> () error ModifyDependencyError;
/// Register a token which will permit the bearer to add either an
/// active or passive dependency upon this element, depending on the
/// dependency_type specified.
flexible RegisterDependencyToken(resource struct {
  token DependencyToken;
  dependency_type DependencyType;
}) -> () error RegisterDependencyTokenError;
/// Unregister a token previously registered via RegisterDependencyToken.
flexible UnregisterDependencyToken(resource struct {
  token DependencyToken;
}) -> () error UnregisterDependencyTokenError;
};
type DependencyType = strict enum {
  ACTIVE = 1;
  PASSIVE = 2;
};
/// Power dependency from an already specified element's PowerLevel to another.
/// The dependent Element should already be known from context.
type LevelDependency = resource struct {
  dependency_type DependencyType;
  dependent_level PowerLevel;
  /// Must supply a token registered via the RegisterToken call of the
  /// required element's ElementControl protocol.
  requires_token DependencyToken;
  requires_level PowerLevel;
};
/// A token that represents the right to add either an active or passive
/// dependency upon the associated element. Must first be registered with Power
/// Broker via ElementControl.RegisterDependencyToken of the required element.
alias DependencyToken = zx.Handle:EVENT;
```

For one or more of these protocols, authorization to take action may be controlled by access to a channel that is scoped to a power element that is to be modified. A power element owner may transfer these channels to another component or power element owner. For example, a power element owner may pass a LevelControl channel to an operator to assign the responsibility of managing power levels of an owned power element to that operator. However, for dependencies, authorization may be provided by both the owner of the dependent power element and the owner of the required power element. To implement this, DependencyTokens may be used, which are represented by an event kernel object that gives the bearer the right to add an active or passive dependency on the associated power element. In order to add a dependency for an owned power element, or remove a previously added dependency, a power element owner acquires, from the owner of the required power element, a DependencyToken for the respective type of dependency to be added. Authorization can be revoked by a power element owner through UnregisterDependencyToken.

ElementControl.OpenStatusChannel allows a power element owner to open a new status channel to monitor the current power level of an owned power element. This enables a power element owner to provide read-only access to the current power level of an owned power element to other clients (e.g., statistics collectors) by opening and transferring that channel. The following is example pseudocode:

```
open protocol Status {
  /// Returns the current power level for this element, non-blocking.
  flexible GetPowerLevel() -> (struct {
    current_level PowerLevel;
  }) error StatusError;
  /// Returns the current power level for this element. If no change has
  /// occurred since the last level was sent, the call will block until
  /// the level changes.
  flexible WatchPowerLevel() -> (struct {
    current_level PowerLevel;
  }) error StatusError;
};
```

Power element owners (or their delegates) may use a LevelControl channel opened by Topology.AddElement to keep a power broker notified of current power levels of owned power elements via UpdateCurrentPowerLevel and receive real-time direction from WatchRequiredLevel regarding which power level their power elements are to maintain. The power broker may use a power topology to determine the minimum power equilibrium and direct power element owners to maintain a corresponding power level. When needs of a system or device change, as communicated to the power broker via acquiring and/or dropping leases, the power broker may perform power-up or power-down operations across the power topology to change power levels of power elements in a sequence according to power level dependencies.

Power element owners (or their delegates) are responsible for informing a power broker of current power levels of owned power elements via UpdateCurrentPowerLevel and monitoring for changes in power levels (e.g., required power levels) via WatchRequiredLevel. If WatchRequiredLevel returns a new required level for a power element, then the owner of that power element makes internal changes to transition to the required power level, and then inform the power broker of the transition by updating the power broker with new power level via UpdateCurrentPowerLevel.

Owners of managed power elements may use both WatchRequiredLevel and UpdateCurrentPowerLevel whereas consumer power elements and limiter power elements may use only UpdateCurrentPowerLevel. The following is example pseudocode:

```
open protocol LevelControl {
  /// Returns the required power level for this element. If no change has
  /// occurred since the last level was sent, the call will block until
  /// the level changes.
  flexible WatchRequiredLevel() -> (resource struct {
    required_level PowerLevel;
  }) error RequiredLevelError;
  /// Sent by the element on initial startup and whenever there is a change
  /// in power level.
  flexible UpdateCurrentPowerLevel(resource struct {
    current_level PowerLevel;
  }) -> () error UpdateCurrentPowerLevelError;
};
```

Owners of consumer power elements may acquire and drop leases via a Lessor protocol. Dependencies of power levels of a power element may be previously registered with a power broker via ElementControl.AddDependency. The power broker then attempts to satisfy direct and transitive dependencies of the power level specified in a lease request in an order that satisfies the dependencies of each power element throughout the transition. If an owner of a consumer power element owner wants to raise the power level of an owned power element, then the owner requests a lease for a requested power level via Lease. The lease request signals to the power broker that the owner wants to transition that power element to a higher power level, and that the owner requests power level dependencies of that higher power level be satisfied. The following is example pseudocode:

```
open protocol Lessor {
  /// Request made to indicate client intends to raise the given element
  /// to the given power level and wants to have its direct and transitive
  /// power dependencies satisfied.
  flexible Lease(resource struct {
    /// Power level this element is intended to be raised to.
    level PowerLevel;
  }) -> (resource struct {
    /// Channel for actions to be taken on the lease.
    /// When this channel is closed, the lease will be dropped.
    lease_control client_end:LeaseControl;
  }) error LeaseError;
};
```

If a lease is granted, the owner of the associated power element may use Lessor.Lease, which returns a LeaseControl channel, to monitor for changes to the status of the lease. If the client end of a LeaseControl channel is closed, then the lease is dropped and the dependencies will be powered down orderly. A power broker may use closure of a LeaseControl channel to detect client component crashes and drop their lease(s). The following is example pseudocode:

```
open protocol LeaseControl {
  /// Get the current status of the lease. If no change has occurred since
  /// the last status was sent, the call will block until the status changes.
  flexible WatchStatus() -> (struct {
    status LeaseStatus;
  });
};
type LeaseStatus = flexible enum {
  UNKNOWN = 0;
  PENDING = 1;
  SATISFIED = 2;
  REJECTED = 3;
  REVOKED = 4;
};
```

### Power-Up and Power-Down

In order for a power element to increase its power level, all power level dependencies for that higher power level must be satisfied first. This can lead to a chain of transitions to increased power levels (also referred to as dependency chains or chains of dependencies) across multiple power elements, starting from the ends of the dependency chains. Ends of a dependent chain either have no power level dependencies or their dependencies have already been satisfied. This sequence of operations to satisfy the power level dependencies in order to raise the power level of a particular power element is referred to as a power up-operation. A power-up operation may be driven by a lease request from a consumer element.

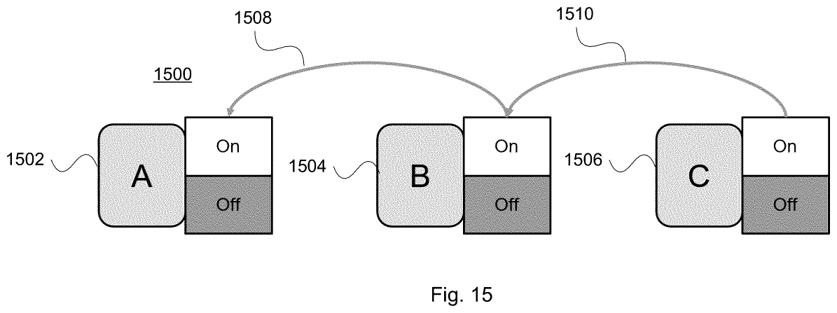

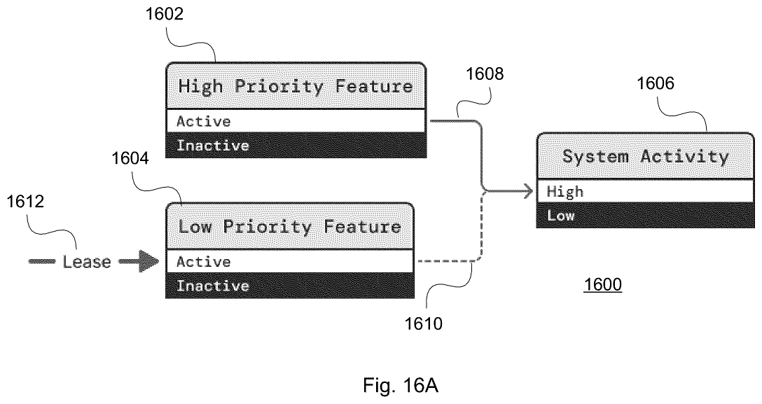

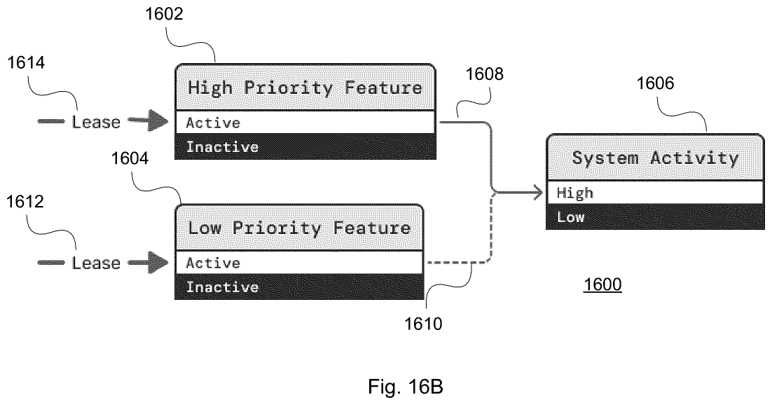

FIG. 15 illustrates a power topology 1500 in accordance with aspects of the technology. The power topology 1500 includes power element A 1502, power element B 1504 and power element C 1506. The power element A 1502 and the power element B 1504 are managed power elements, each having binary “on” and “off” power levels. The power element C 1506 is a consumer power element having binary “on” and “off” power levels. The current power levels of the power element A 1502, the power element B 1504 and the power element C 1506 are the on power levels. As indicated by arrow 1508, the power element B 1504 being at the on power level depends on the power element A 1502 being at the on power level. As indicated by arrow 1510, the power element C 1508 being at the on power level depends on the power element B 1504 being at the on power level.

The following is an example sequence of operations for the power element C 1508 requesting a lease to be at the on power level, which requires the power element B 1504 to be at the on power level. The power element C 1506 (or an owner thereof) communicates a lease request to a power broker for the power element C 1506 to be at the on power level. The power broker examines the power topology 1500 and determines that there are no dependencies associated with limiter power element dependencies that would prohibit the lease request. Thus, the power broker responds with a pending lease. The power broker then examines the power element dependencies for the on power level of the power element B 1504 and traverses the power topology 1500 until a transitive dependent power level having no unsatisfied power level dependencies is found. Here, the power broker finds that the power element B 1504 being at the on power level depends on the power element A 1502 being at the on power level.

Thus, the power broker instructs the power element A 1502 (or an owner thereof) to transition to the required power level: the on power level. The power element A 1502 responds with acknowledgement of the required power level, completes the transition to the on power level, and then notifies the power broker that the power element A 1502 is now at the on power level. As a result, the power broker recognizes that the power element B 1504 no longer has any unsatisfied power level dependencies. Thus, the power broker instructs the power element B 1504 to transition to the required power level: the on power level. The power element B 1504 responds with acknowledgement of the required power level, completes the transition to the on power level, and then notifies the power broker that the power element B 1504 is now at the on power level. As a result, the power broker determines that the power level dependencies of the pending lease have been fully satisfied, and notifies the power element C 1506 of that by updating the pending lease to a satisfied lease. In response, the power element A 1502 responds with acknowledgement of the satisfied lease, completes the transition to the on power level, and then notifies the power broker that the power element C 1502 is now at the on power level.

A sequence of power level transitions to lower the power level of a particular power element is referred to as a power-down operation. A power-down operation may be orderly or disorderly. In an orderly power-down operation, all outstanding power level dependencies are satisfied at each step in the operation. In a disorderly power-down operation, one or more power-level dependencies are unsatisfied (e.g., violated). An orderly power-down operation can be initiated by an owner of a consumer power element that is reducing its power level and, therefore, dropping a previously held lease. The power elements on which that consumer power element was dependent may now reduce their respective power levels and drop their (internal) leases until a minimum level equilibrium is achieved.

Limiter power elements can initiate power-down operations. By way of example, if a limiter power element lowers its power level without warning a power broker and there are power elements with outstanding leases on the higher power level of the limiter power element, then a disorderly power-down operation will occur. In response to such a change by a limiter power element, all power elements in an associated chain of dependencies are notified that their respective power level dependencies are no longer satisfied and instructed to which power level to transition. To avoid a disorderly power-down operation, a limiter power element may provide advance notice to the power broker of an impending transition to a lower power level with a deadline for that transition. The power broker then attempts to perform an orderly power-down operation by informing consumer power elements that their respective leases are going to be revoked and instructing them to transition to lower power levels. If the chain of dependencies is satisfied within the deadline, then an orderly power-down operation is completed. Otherwise, a disorderly power-down operation occurs.

### Untracked Dependencies

In some scenarios, a power topology might not capture all power level dependencies of a system or device. If so, a deadlock state may occur in which lowering the power level of a power element requires a higher power level from an untracked power level dependency of another power element or component that has already been powered down (e.g. the owner of the power element is in pageable memory and the storage driver has already been powered down). In such a deadlock state, a consumer power element may be created to account for untracked client requests. A lease is then requested for this consumer power element, which causes the required power element to raise its power level thereby resolving the deadlock state. Usages of this consumer power element can be later interrogated through forensics so that untracked dependencies can be identified and addressed.

### Logging and Diagnostics

Because the power broker maintains an internal representation of power levels of power elements associated therewith, the power broker may output logging, tracing and/or telemetry to diagnose and/or debug power consumption issues in a system or device. These structured logs may be a data source for tools to help visualize and replay where, when, and/or why power is being consumed in the system or device.

### Opportunistic Dependency on a Managed Power Element

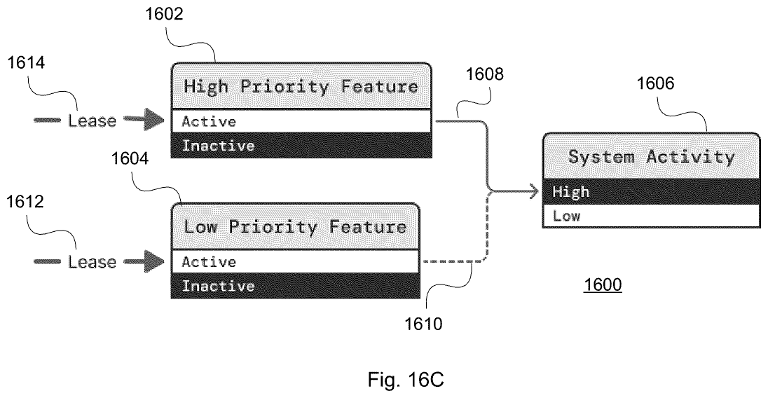

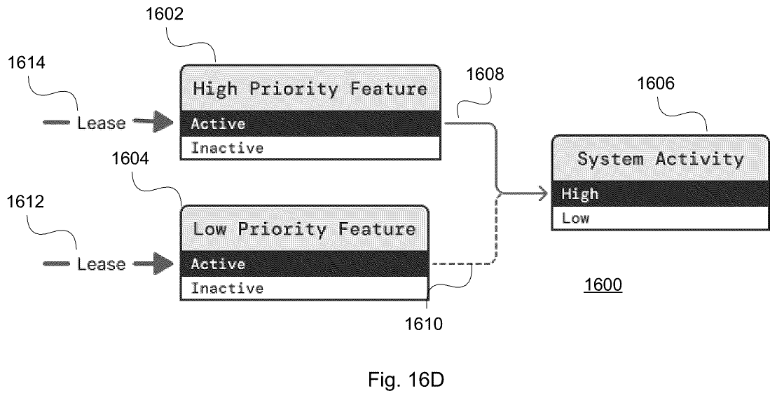

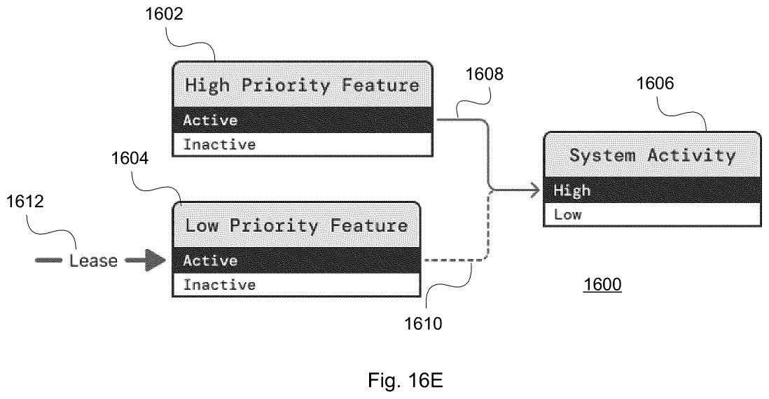

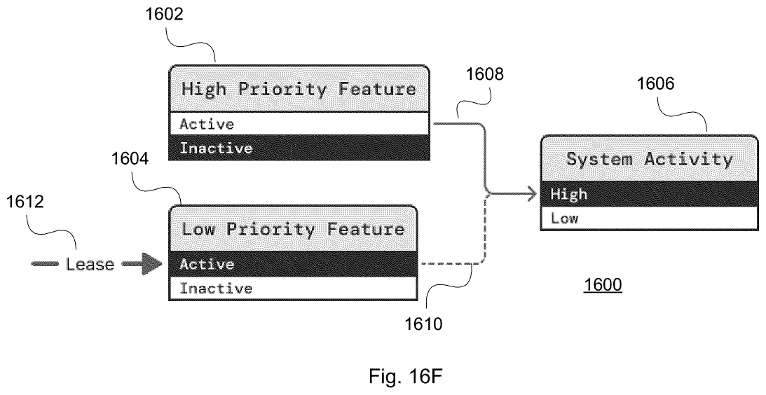

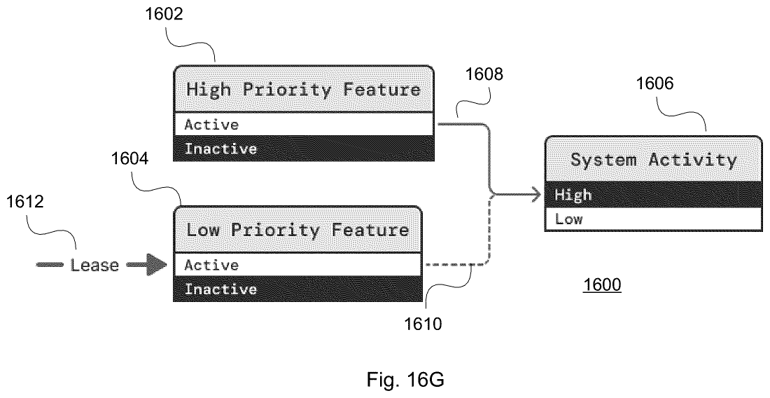

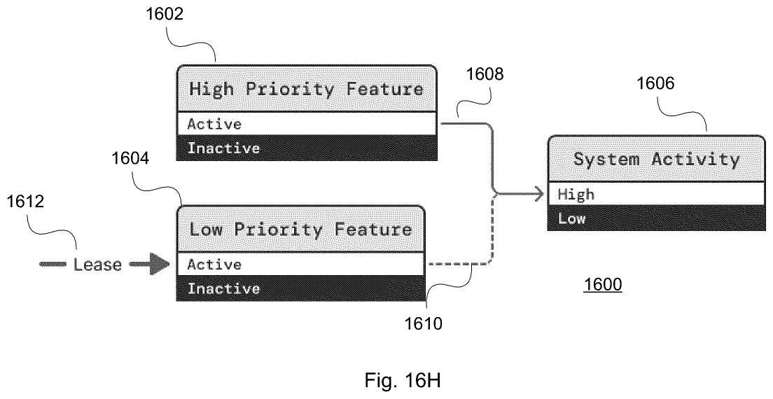

FIGS. 16A-H illustrate example power management of a power topology 1600 of a system in accordance with aspects of the technology. The power topology 1600 includes a power element 1602 representing a high priority feature of the system and a power element 1604 representing a low priority feature of the system. The power elements 1602 and 1604 have respective “active” and “inactive” power levels.

The power topology 1600 includes a power element 1606 representing system activity of the system. System activity refers to the breadth of task processing allowed by the system. The power element 1606 has “high” and “low” power levels. When the power element 1606 is at the high power level, the system processes a wide variety of tasks. When the power element 1606 is at the low power level, the system processes tasks much more selectively.

As indicated by arrows 1608 and 1610, in order for either of the high priority and low priority features (the power elements 1602 and 1604) to be active, the system activity (the power element 1606) needs to be at the high power level. The power level dependency of the power element 1602 on the power element 1606 (the arrow 1608) is assertive. Thus, the power level of the power element 1606 is raised to the high power level if required by a lease. However, the power level dependency of the power element 1604 on the power element 1606 (the dashed arrow 1610) is opportunistic. Thus, the power level of the power element 1604 is raised to the active power level only after a lease on the power element 1602 raises the power level of the power element 1606 is raised to the high power level.

In FIG. 16A, the current power level of the power element 1602 is the inactive power level(indicated by the shading), the current power level of the power element 1604 is the inactive power level(indicated by the shading), and the current power level of the power element 1606 is the low power level(indicated by the shading). There is a lease 1612 pending on the active power level of the power element 1604. However, a power broker does not satisfy the lease 1612 because the dependency on the high power level of the power element 1606 is opportunistic.

In FIG. 16B, a lease 1614 is pending on the active power level of the power element 1602, which changes the steady state of the system. In FIG. 16C, the power level of the power element 1606 is raised to the high power level(indicated by the shading). In FIG. 16D, the power levels of both the power elements 1602 and 1604 are raised to the respective active power levels (indicated by the shading). Thus, both the leases 1612 and 1614 are granted. The power levels of the power elements 1602 and 1604 can be raised in any order. In FIG. 16E, the lease 1614 is revoked (e.g., dropped). In the resulting steady state, the lease 1612 is no longer satisfied. However, the lease 1612 is not necessarily revoked. In FIG. 16F, the power level of the power element 1602 is lowered to the inactive power level(indicated by the shading). In FIG. 16G, to maintain orderliness, the power element 1606 remains at the high power level until the power level of the power element 1604 is lowered to the inactive power level. Here, the power level of the power element 1604 has been lowered to the inactive power level. Although opportunistic power level dependencies differ from assertive power level dependencies in how they are fulfilled, the power broker treats both opportunistic and assertive power level dependencies equally when ensuring orderliness of power-down sequences. In FIG. 16H, the power level of the power element 1606 is lowered to the low power level(indicated by the shading).

### Error State Power Elements

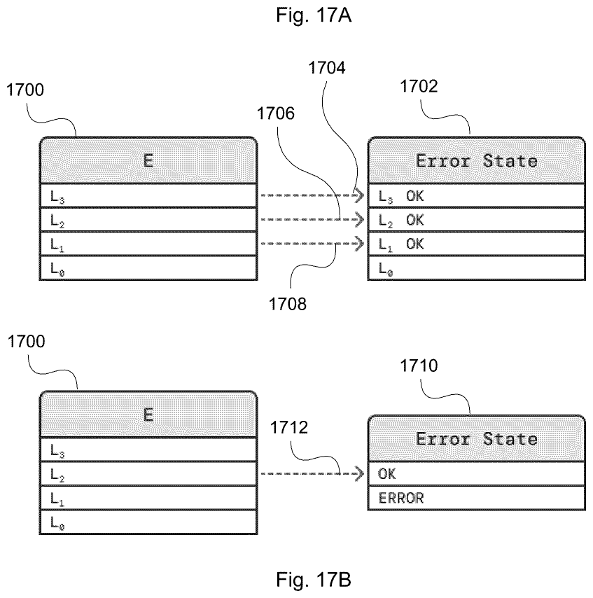

A power element owner can model error states using an unmanaged power element that inhibits the operability of certain power levels. FIGS. 17A-B illustrates example error power elements in accordance with aspects of the technology. FIGS. 17A-B illustrate a power element 1700 having power levels L₀, L₁, L₂ and L₃. This mechanism serves to, in effect, disable a contiguous block of power levels at the top of a power element's schema.

FIG. 17A illustrates an error state power element 1702, which is unmanaged, having four power levels L₀, L₁ OK, L₂ OK, and La OK that directly mirror the power levels L₀, L₁, L₂ and L₃ of the power element 1700. As indicated by dashed arrow 1704, the L₁ power level of the power element 1700 has a basic dependency on the L₁ OK power level of the error state power element 1702. Thus, if the current power level of the error state power element 1702 is the L₁ OK power level, then the highest power level that the power element 1700 can be at is the L₁ power level. As indicated by dashed arrow 1706, the L₂ power level of the power element 1700 has a basic dependency on the L₂ OK power level of the error state power element 1702. Thus, if the current power level of the error state power element 1702 is the L₂ OK power level, then the highest power level that the power element 1700 can be at is the L₂ power level. As indicated by dashed arrow 1708, the L₃ power level of the power element 1700 has a basic dependency on the L₃ OK power level of the error state power element 1702. Thus, if the current power level of the error state power element 1702 is the L₃ OK power level, then the highest power level that the power element 1700 can be at is the L₃ power level.

FIG. 17B illustrates an error state power element 1710, which is unmanaged, having two power levels: “OK” and “ERROR”. As indicated by dashed arrow 1712, the L₂ power level of the power element 1700 has a basic dependency on the OK power level of the error state power element 1710. Thus, if the current power level of the error state power element 1710 is the ERROR power level, then operation of the power element 1700 at the L₂ and L₃ power levels are inhibited.

### Attribution

A power broker may support attribution of current power levels to leases that they fulfill. A power broker may support differentiation between leases that assertively require a given power level and leases that opportunistically require it.

### Observability

A power broker may expose information about power elements, including their power level schemas and their dependencies (e.g., via diagnostics). A power broker may maintain a record of leases and power level transitions (e.g., over a configurable time window). This information maintained and/or provided by the power broker facilitates inspection of a state of a power topology (e.g., at the time of a query) and enables playback of a history of a power topology.

### Transition Latency Support

A power topology provides a framework for understanding and optimizing latencies of system state transitions. Definitions of power element may establish a canonical location to encode expectations for local power level transition latencies (e.g., the amount of time to change a power level of a power element after all power level dependencies are satisfied). Although limits on local power element latencies may not be used initially, but limits on local power element latencies can be added as a given system matures. Non-limiting examples of applications of local power elements latencies include semi-static analysis (e.g., by capturing the power topology configuration at runtime) of latencies of composite operations spanning multiple power elements, runtime tracking of observed latencies and reporting on departures from expectations, and reporting of latency estimates to clients so as to support operations with aggressive timing requirements.

### Other Types of States and Power Level Dependencies

Power levels and power level dependencies as described herein are useful for representing power element states for a variety of reasons. They provide a way to capture dependencies between significant numbers of states in ways that aggregate rather than requiring cumbersome repetition as in other approaches. As a power topology evolves, it may be useful to support other kinds of states and power level dependencies. By way of example, a sensor's firmware might be implemented to support a set of disjoint operating modes, each of which is optimized to satisfy different requirements, but which do not abide by a scale of strictly increasing functionality and power use. Although such a sensor might be described by one binary power element for each mode, a power element state schema may describe all modes simultaneously and include rules to resolve conflicts between competing clients. By way of example, some types of hardware, such as GPUs, may have power levels chosen based on simultaneous load requirements of multiple clients. A power topology may support power level dependencies that capture such load requirements and accumulate them.

### Suspend-to-Idle

Aspects of the technology provide a suspend-to-idle flow. Power management may include taking a system to a lower power level when the system is not actively being used and subsequently bringing the system back to fully functional. System power levels may be compared to ACPI S states. Different types of systems may have different requirements for power and wake latency. These requirements may determine power levels to which a system can transition. Power management of an active (e.g., fully-on) system by turning off or transitioning components or devices of the system to lower power levels may be referred to as runtime power management.

Merely defining a set of system power levels and implementing only those defined power levels does not achieve the goal of reaping the best possible power benefits while honoring system resume time latencies limits. Other approaches attempt to retrofit runtime power management, which do not realize full power benefits.

To address these deficiencies of other approaches, aspects of the technology include granular level power management using a centralized power topology and power managing components (e.g., power broker) to make and implement decisions according to that power topology and policies thereof. A component or device of a system (e.g., SoC, peripheral, bus) may define its power levels with corresponding wake latencies and communicate (e.g., publish) those power levels and corresponding wake latencies to the power topology and/or power broker. The power broker may make informed policy decisions and implement those decisions to transition the system, or components or devices thereof, to a lower power level. By way of example, the power broker may make decisions based on 1) information received from user space system components (e.g., a request to transition a system to a lower power level with a guaranteed resume time), 2) configuration information (e.g., system power levels, resume time and wake capabilities for each power level) and/or 3) the current power level(s) of the system (e.g., power levels of components or devices, their wake latencies, their power resource dependencies and/or their I/O queues).

By way of example, a power broker may receive a request from components in user space of a system to transition the system to a lower power level with a guaranteed resume time of 500 milliseconds (ms). The guaranteed resume time is the maximum amount of time to resume (e.g., transition the system from that lower power level to a higher power level). The power broker may be aware of power levels of components or devices of the system and some or all wake latencies of those power levels. Based on this information, the power broker may determine, based on a power topology, which component(s) of the system to take to lower power levels. By way of example, a power broker may cause secondary CPUs and audio speakers of the system to a power level associated with being offline, WiFi of the system to transition to a lower power level, and a display of the system to transition to a lower power level associated with a lower (slower) refresh rate. Because these components or devices can be restored back to fully functional within 500 ms, the guaranteed resume time is satisfied. However, the power broker does not transition any other components or devices of the system to lower power levels, because those components or devices either require to be always-on or their wake latencies are greater than 500 ms.

By way of example, a power broker may receive a request from components in user space of a system to transition the system to a lower power level because there is no active user interaction. Here, the request does not have a resume time requirement in which to exit the system from the lower power level. Thus, the power broker may decide to transition the system to a suspend-to-Idle power level and then transition the system to a suspend-to-RAM power, if possible.

For devices and systems that are battery operated, power management is an important feature. Aspects of the technology enable drivers, components and devices of a system to be “power aware” by implementing protocols and interfaces. Aspects of the technology also enable drivers, components and devices of a system to be agnostic to system power level changes. Further aspects of the technology enable changes to power policy enforcement (e.g., system power level transition, runtime power management) without having to change driver code.

A suspend-to-idle power level is a low power system power level that is supported in multiple operating systems. However, each operating system may define a suspend-to-Idle power level differently. A suspend-to-idle power level, as used herein, is based on the ACPI S1 state, which is defined as a low wake latency sleep state in which all system context is preserved except for CPU caches. Before entering S1, the system caches are flushed, and the hardware is expected to: (1) place the processor in a stop grant state, (2) stop the processor input clock, placing the processor into the stop clock state, (3) place system memory into a self-refresh or suspend-refresh state, and (4) stop all system hardware clocks. However, the technology is not limited to a suspend-to-idle power level based on the ACPI S1 state. Table 1 provides an example implementation of a suspend-to-idle power level.

TABLE 1

| Power Element | Power Level |
|---|---|
| Boot CPU | Level 4 |
| Non-Boot CPU | Lowest possible of Levels 0-3 |
| Memory | Level 1 |
| Subsystems | Lowest possible |
| Clock Trees & Power Rails | Best effort |

By way of example, a power element representing a boot CPU may have the following power levels: level 4 (e.g., c0) where the boot CPU is fully on; level 3 (e.g., c1) where the boot CPU is on but a core clock is stopped; level 2 (e.g., c2) where the boot CPU is on but a core clock and a bus clock are stopped; level 1 (e.g., c3) where the boot CPU is on and a clock generator is off; and level 0 (e.g., c4) where the boot CPU operates at a reduced voltage.

By way of example, a power element representing a non-boot CPU may have the following power levels: level 4 (e.g., c0) where the non-boot CPU is fully on, level 3 (e.g., c1) where the non-boot CPU is stopping clock, level 2 (e.g., c2) where the non-boot CPU is stopping clock and operating at a reduced voltage, level 1 (e.g., c3) where the non-boot CPU is stopping clock, operating at a reduced voltage, and turning off caches, and level 0 (e.g., c4) where the non-boot CPU is fully off.

By way of example, a power element representing memory may have the following power levels: level 2 where the memory is fully on, level 1 where the memory is in a self-refresh mode, and level 0 where the memory is fully off.

Non-limiting examples of subsystems include audio, Bluetooth®, graphics, storage, and WiFi. By way of example, a power element representing a subsystem may have the following power levels: level 1 where that subsystem is fully on, and level 0 where that subsystem is fully off.

Executing a command to transition a system to a low power state (e.g., a suspend-to-idle power level) may be based on one or more of: a power topology of the system, power level dependencies, current power levels of components or devices of the system, and/or status of the system (e.g., CPU, memory, clock, power level). Because the power broker has knowledge of the status of CPU, clock tree, memory and/or power rail, the power broker may make decisions in association with suspending the system in a failsafe way. Corresponding drivers or the kernel may expose interfaces of the power broker and power topology to query the current power level and system calls to execute a set of activities during suspend and resume. The power broker and/or power topology may receive user configuration information for a suspend-to-idle power level and a resume power level(e.g., wake capabilities, resume latency).

The power broker may determine wake capabilities before transitioning the system to a lower power level. The power broker may generate and/or maintain lists of components or devices of the system that are capable of waking up from different low-power power levels based on configuration information accessible to the power broker. Drivers that know or learn that they can wake the system from lower power levels may register their interrupts with the power broker so as to be wake-capable. The power broker may use this information, along with configuration information, system configuration information, and user space configuration information, to decide which components or devices of the system are wake capable and communicate that information to a kernel.

### Transition to Suspend-to-Idle

A power broker may be responsible for transitioning an entire system in or out of a given system power level. If a request to transition the system to a given system power level is received by the power broker but the given system power level is not supported by the system, then the power broker may reject the request. By way of example, a suspend-to-idle system power level is a low wake latency sleep state. The power broker may maintain power levels of components and/or devices of a system, and/or power states of the system as a whole (also referred to as system power levels).

Decisions to transition the system in and out of a power level and decisions to reject a requested transition may be handled internally by the power broker. A system may be at a given system power level when the power broker receives a request to transition the system to another system power level. The power broker may know the current system power level and transitions to power levels of components and/or subsystems of that system in order to transition the system to the other system power level. Some transitions to system power levels might be unsuccessful such that the system power level is not changed. Such scenarios are handled by the power broker. The power broker may be aware of the resulting power level after every transition, even if the transition is unsuccessful.

A system may have multiple power states, such as off, on, suspend-to-idle, suspend-to-RAM, and/or suspend-to-disk, for example. For a power state, CPU(s), memory and/or subsystem(s) may be required to be at different power levels. If changing the power levels of the subsystems, CPU or memory would transition the system to transition from one power state to another power state, then the power broker might not initiate such a change because the power broker is maintaining a particular power state of the system. By way of example, if the current power state of a system is suspend-to-idle, and a request is received to transition memory to an “off” power level, then the power broker will not transition memory to that “off” power level because doing may cause the system to transition from the “suspend-to-idle” power state to a “suspend-to-disk” power state.

When a system decides to go to a suspend-to-idle system power level(e.g., to save power or battery), the power broker may know states of the system via the power topology. The power broker may decide which components and/or devices of the system to transition to lower power levels, and then invoke an interface to transition those components and/or devices to those lower power levels. Components and/or devices of a system may register and implement the interfaces (e.g., for protocols between the power broker and components and/or devices of the system) to transition their power levels defined by the power broker to reap the best power benefits.

The power broker may invoke interfaces of owners of power elements to program or configure wakeup triggers for those power elements. The power broker may request a kernel to configure the hardware for wakeup.

If a component or device of a system fails to transition to a power level as instructed by the power broker, the power broker may determine to abort the transition of the system to a system power level, or continue the transition of the system to that system power level despite the failed transition of that component or device. By way of example, the power broker may initiate one or more requests to pause the monotonic time, take CPU(s) offline or transition the CPU(s) to a lower power level, turn off the clock and power domains as much as possible, and other architecture dependent actions, if any. These requests may be direct system calls to the kernel or routed through a component (e.g., a driver), device or HAL of a system.

Resume from Suspend-to-Idle

A system may resume from a suspend-to-idle power level when a boot CPU receives an interrupt to wake up. Wake capable interrupts, configured in an interrupt controller, a power management integrated circuit (PMIC), and/or locally at a component or device of the system, may be delivered by the hardware to the CPU. However, all interrupts might not trigger a resume. Rather, interrupts that trigger a resume may be decided and/or configured by the power broker before transitioning the system to the suspend-to-idle system power level.

Because a boot CPU is not taken offline when the system is transitioned to the suspend-to-idle system power level, an interrupt is communicated to the boot CPU, which then invokes a corresponding interrupt service routine. The power broker may receive the status for its suspend call directly from the kernel as a system call function returns or routed through a component (e.g., driver) of the system. That component and/or the power broker may perform the actions associated with (e.g., may cause) transitioning the system to the suspend-to-idle system power level in the reverse order so as to transition the system from the suspend-to-idle system power level to a higher system power level. By way of example, the power broker may, in order, enable clock and power domains, transition the boot CPU to a higher power level(e.g., a power level associated with a fully functional state), transition the secondary CPUs to a higher power level, exit memory out of self-refresh, and other architecture dependent actions, if any. The power broker may be responsible for resuming the components and devices of the system in an orderly fashion.

### Drivers Registering as Wake Capabilities

Device drivers may receive information about whether their interrupt(s) are wake capable from another driver or other sources based on the type of the device driver and the architecture. By way of example, an interrupt generated from an audio, touch and/or lid device may be wake capable. Corresponding device drivers call ACPI SetWakeDevice( ) as a part of the suspend function to register as wake sources.

Because a power broker is a centralized component for deciding power related settings, the power broker may determine which components and/or devices may wake the system from a system power level(e.g., a system power level to which the power broker has previously transitioned the system. Drivers that have wake capable interrupts may communicate such information to the power broker (e.g., via a predefined and shared channel). The power broker may set up wakeup triggers with a kernel system call or via communication with a corresponding driver.

### Provisioning Power Configurations

Configurations and/or properties of a system may be used to make power policy decisions. By way of example, these configurations and/or properties may include components and/or devices of a system that are dependent on one another, support for different system power levels, and/or which components and/or devices of a system are wake capable (e.g., can wake the system from lower power levels). For example, components and/or devices may be allowed to wake the system from a suspend-to-idle system power level, but may not be allowed to wake the system from a suspend-to-RAM system power level. The power broker may know which components and/or devices of a system are allowed to wake the system from a power level to which the power broker is transitioning or has transitioned the system. By way of example, a configuration of a system may be configuration information that is read by the power broker after booting up the system. This configuration information may be communicated to device drivers. These device drivers may then process that configuration information and communicate other (e.g., final) configuration information to the power broker during their respective initializations and/or registrations.

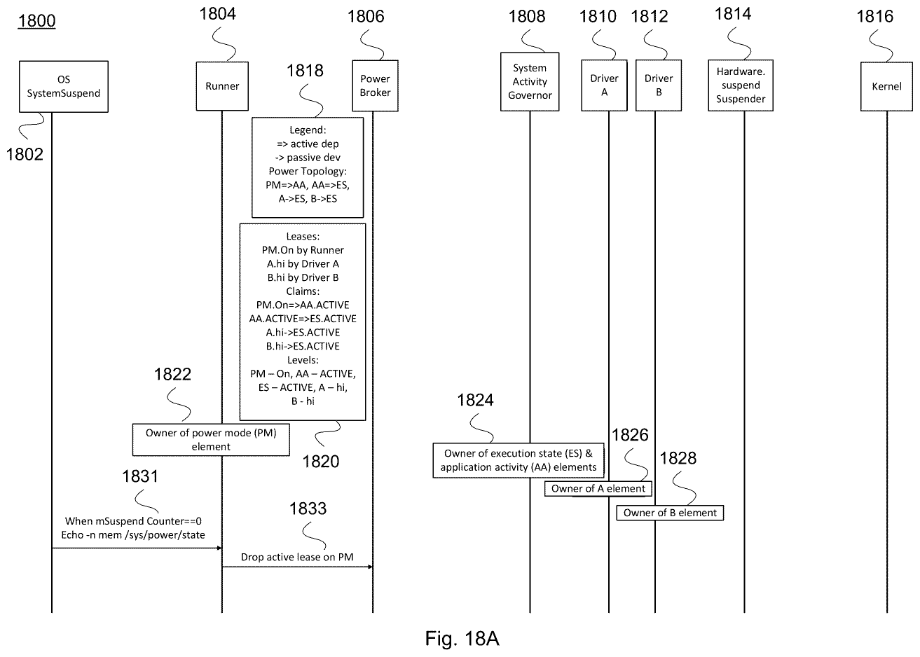

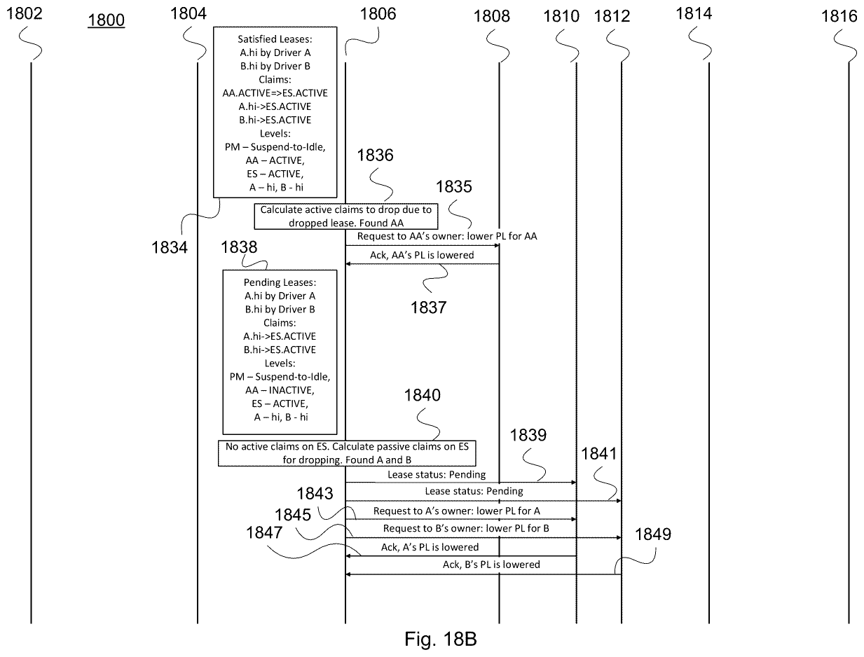

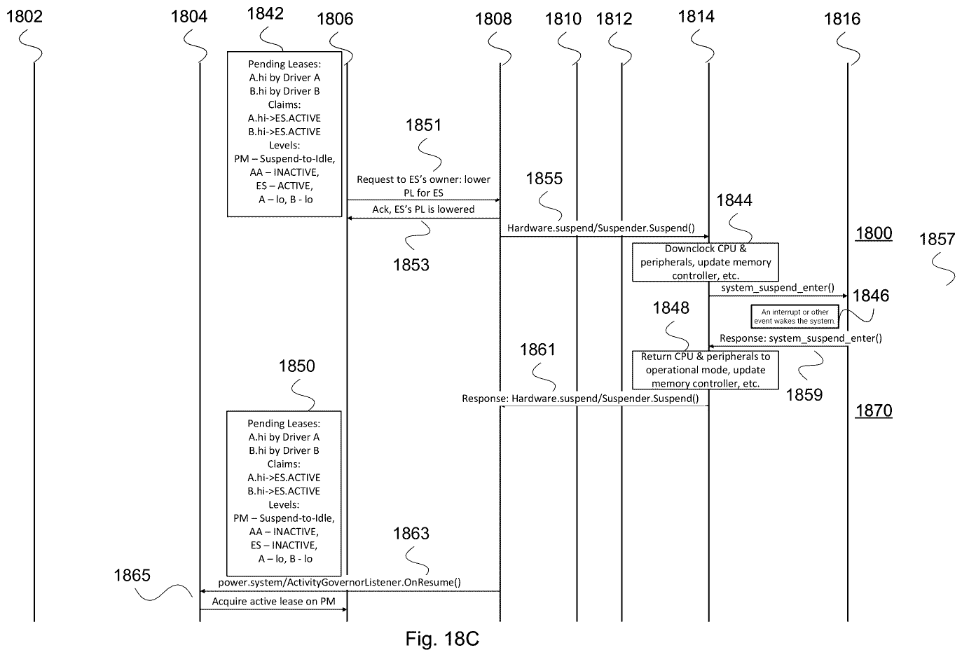

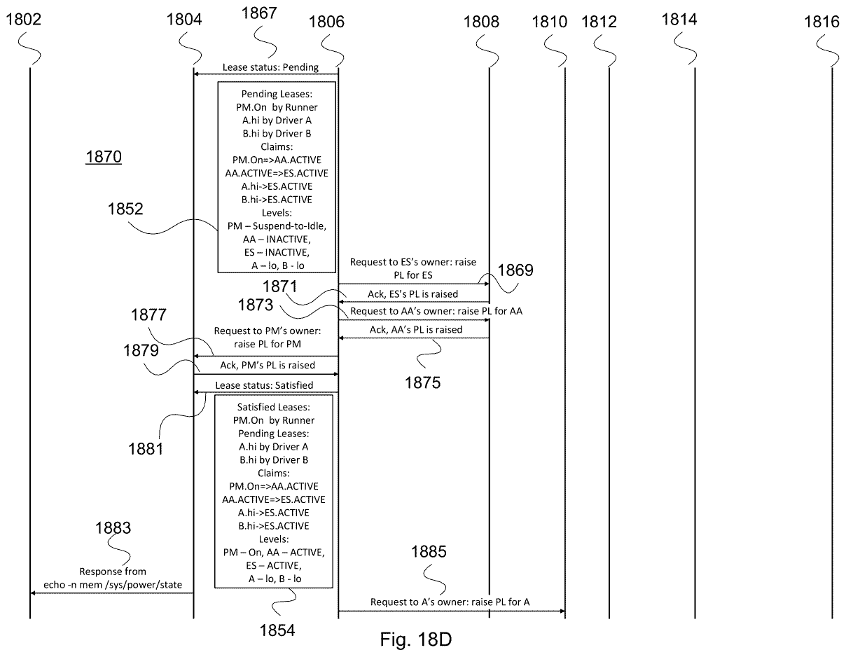

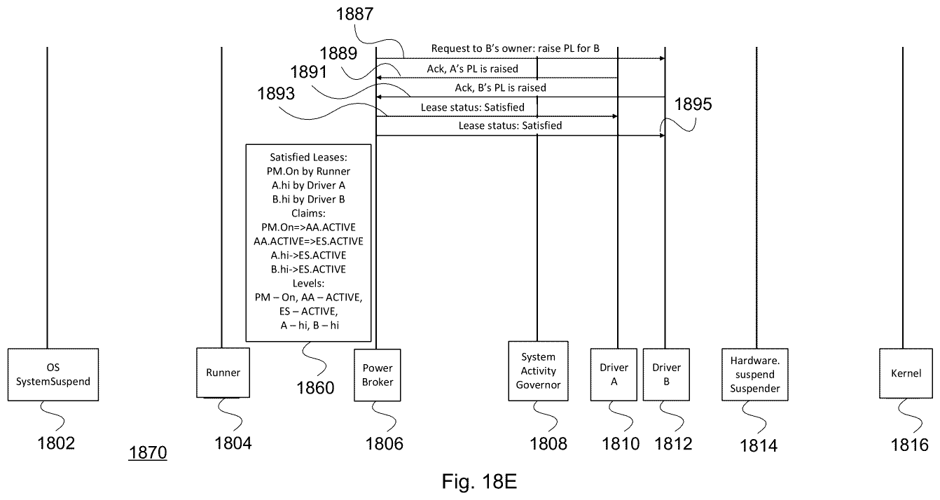

FIGS. 18A-E illustrate an example suspend-to-idle flow 1800 and an example resume flow 1870 in accordance with aspects of the technology. The suspend-to-idle and resume flow 1800 is associated with a power topology of a system. As indicated at 1818, the power topology includes five power elements: A, B, power mode (PM), application activity (AA) and execution state(ES).

The application activity power element is owned by the system activity governor 1806. The application activity power element may indicate to the system activity governor 1806 whether or not one or more applications (e.g., user space) need the system to be awake. All leases on the application activity power element being dropped indicates that no applications require the system to be awake. However, if there is at least one lease on the application activity power element, then that indicates that the system needs to be awake.

The execution state power element is owned by the system activity governor 1806. The execution state power element may determine when a kernel should be instructed to transition one or more CPUs of the system to a lower power state. If there are no leases on the execution state power element, then the system activity governor 1806 will lower the power level of the execution state power element and instruct a kernel to take one or more CPUs to a lower power level.

As indicated at 1826, driver A 1810 of the system is the owner of the A power element. As indicated at 1828, driver B 1812 of the system is the owner of the B power element. As indicated at 1822, runner 1804 of the system is the owner of the power mode power element. The runner 1804 provides a runtime environment for other components. The runner 1804 may be a layer between an operating system and one or more applications (e.g., user space) to translate calls from the user space to be understandable by the operating system.

As indicated at 1824, system activity governor 1806 of the system is the owner of the application activity power element and the execution state power element. The power mode power element has an active power level dependency on the application activity power element. The application activity power element has an active power level dependency on the execution state power element. The A power element and the B power element each have a passive power level dependency on the execution state power element.

As indicated at 1820, the state of the system at the initialization of the suspend-to-idle flow 1800 includes three active (or satisfied) leases and no pending leases. The runner 1804 has lease for the power mode power element to be at its on power level. This lease includes a claim for the application activity power element to be at the active power level because the on power level of the power mode power element is actively dependent on the active power level of the application activity power element. This lease also includes a claim for the execution state power element to be at “active” power level because the active power level of the application activity power element is actively dependent on the active power level of the execution state power element.

The driver A 1810 has lease for the A power element to be at its “hi” power level. This lease includes a claim for the application execution power element to be at the active power level because the hi power level of the A power element is passively dependent on the “active” power level of the execution state power element.

The driver B 1812 has lease for the B power element to be at its “hi” power level. This lease includes a claim for the application execution state element to be at “active” power level because the hi power level of the B power element is passively dependent on the active power level of the execution state power element.

Because of these leases, the current power level of the power mode power element is the on power level, the current power level of the application activity power element is the active power level, the current power level of the execution state power element is the active power level, the current power level of the A power element is the hi power level, and the current power level of the B power element is the hi power level.

The suspend-to-idle flow 1800 begins at 1831, with operating system suspend 1802 sending a command to the runner 1804 to enter a suspend-to-idle mode. In response to this suspend command, at 1833, the runner 1804 communicates to power broker 1806 that the runner 1804 is dropping the lease on the power mode power element being at the on power level. The current power level of the power mode power element is now its “suspend-to-idle” power level. After the lease on the power mode power element is dropped, as indicated at 1834, only the leases on the A power element and the B power element are satisfied. At 1836, the power broker 1806 determines (e.g., calculates) which active claims can be dropped now that the lease on the power mode power element has been dropped. Here, the power broker 1806 determines that the claim for the application activity power element to be at its “active” power level can be dropped. Thus, at 1835, the power broker 1806 communicates to the system activity governor 1808 to lower the application activity power element from the active power level. The system activity governor 1808 then causes the application activity power element to lower its power level and after doing so, at 1837, communicates to the power broker 1806 an acknowledgment indicating that the power level has been lowered. The current power level of the application activity power element is now “inactive” power level.

After the power level of the application activity power element is lowered, as indicated at 1838, there are no active leases because the power level dependencies of the A power element and the B power element are passive. Thus, the leases on the A power element and the B power element are now pending. At 1840, the power broker 1806 determines (e.g., calculates) that there are no active claims on the execution state power element. As a result, the power broker 1806 determines (e.g., calculates) which passive claims can be dropped. Here, the power broker 1806 determines that the claims for the A power element to be at the hi power level and the B power element to be at the hi power level can be dropped. Thus, at 1839, the power broker 1806 communicates to the driver A 1810 that the lease on the A power element is pending and, at 1841, the power broker 1806 communicates to the driver B 1812 that the lease on the B power element is pending. At 1843, the power broker 1806 communicates, to the driver A 1810, to lower the A power element from the hi power level. The driver A 1810 then causes the A power element to lower its power level and after doing so, at 1847, communicates, to the power broker 1806, an acknowledgment indicating that the power level has been lowered. The current power level of the A power element is now its “10” power level. At 1845, the power broker 1806 communicates, to the driver B 1812, to lower the B power element from the hi power level. The driver B 1812 then causes the B power element to lower its power level and after doing so, at 1849, communicates, to the power broker 1806, an acknowledgment indicating that the power level has been lowered. The current power level of the B power element is now “10” power level.

As indicated at 1842, the execution state power element is still at the active power level even though the power levels of the A power element and the B power element have been lowered. At 1851, the power broker 1806 communicates to the system activity governor 1808 to lower the execution state power element from the active power level. The system activity governor 1808 then causes the execution state power element to lower its power level and after doing so, at 1853, communicates to the power broker 1806 an acknowledgment indicating that the power level has been lowered. The current power level of the execution state power element is now its “inactive” power level.

After the power level of the execution state power element has been lowered to the inactive power level, at 1855, the system activity generator 1808 communicates, to hardware suspender 1814 of the system, a command to suspend hardware of the system. At 1844, the hardware suspender 1814 downclocks CPU(s) and peripheral(s) of the system, and updates memory controller(s) of memory controller(s) of the system. At 1857, the hardware suspender 1814 communicates, to kernel 1816, a command to enter a suspend-to-idle mode. This completes the suspend-to-idle flow 1800.

The resume flow 1870 begins at 1846 where an interrupt or some other event wakes the system from the suspend-to-idle mode. At 1859, the kernel 1816 communicates, to the hardware suspender 1814, a command to exit the suspend-to-idle mode. At 1848, the hardware suspender 1814 returns (e.g., upclocks) CPU(s) and peripheral(s) of the system to an operational mode, and updates memory controller(s) of memory controller(s) of the system. The hardware suspender 1814 communicates, to the system activity generator 1808, a command to return the system to operational.

As indicated at 1850, the current power level of the execution state power element is now the inactive power level. At 1863, the system activity governor 1810 communicates, to the runner 1804, a command to resume the system. In response, as the owner of the power mode power element, at 1865, the runner 1804 requests a lease, from the power broker 1806, on the power mode power element to be at the on power mode. At 1867, the power broker 1806 communicates, to the runner 1804, that the lease is pending.

As indicated at 1852, the lease on the power mode power element is pending. This lease includes a claim for the application activity power element to be at the active power level because the on power level of the power mode power element is actively dependent on the active power level of the application activity power element. This lease also includes a claim for the execution state power element to be at the active power level because the active power level of the application activity power element is actively dependent on the active power level of the execution state power element.

At 1869, the power broker 1806 communicates, to the system activity governor 1808, to raise the execution state power element to the active power level. The system activity governor 1808 then causes the execution state power element to raise its power level and after doing so, at 1871, communicates to the power broker 1806 an acknowledgment indicating that the power level has been raised. The current power level of the execution state power element is now “active” power level.

At 1873, the power broker 1806 communicates to the system activity governor 1808 to raise the application activity power element to the active power level. The system activity governor 1808 then causes the application activity power element to raise its power level and after doing so, at 1875, communicates to the power broker 1806 an acknowledgment indicating that the power level has been raised. The current power level of the application activity power element is now “active” power level.

At 1877, the power broker 1806 communicates, to the runner 1804, to raise the power mode power element to the on power level. The runner 1804 then causes the power mode power element to raise its power level and after doing so, at 1879, communicates to the power broker 1806 an acknowledgment indicating that the power level has been raised. The current power level of the power mode power element is now the on power level. At 1881, the power broker 1806 communicates, to the runner 1804, that the lease is satisfied as indicated at 1854. At 1883, the runner 1804 communicates, to the operating system suspend 1802, a response that the system is exiting the suspend-to-idle mode.

At 1885, the power broker 1806 communicates, to the driver A 1810, to raise the A power element to the hi power level. The driver A 1810 then causes the A power element to raise its power level and after doing so, at 1889, communicates, to the power broker 1806, an acknowledgment indicating that the power level has been raised. The current power level of the A power element is now the hi power level. At 1887, the power broker 1806 communicates to the driver B 1812 to raise the B power element to the hi power level. The driver B 1812 then causes the B power element to raise its power level and after doing so, at 1891, communicates to the power broker 1806 an acknowledgment indicating that the power level has been raised. The current power level of the B power element is now the hi power level. At 1893, the power broker 1806 communicates, to the driver A 1810, that the lease is satisfied as indicated at 1860. At 1895, the power broker 1806 communicates, to the driver B 1812, that the lease is satisfied as indicated at 1860. This ends the resume flow 1870.

### System Activity Governor

To satisfy needs for power-sensitive hardware and/or software, power consumption may be managed by the system. This may include, for example, transitioning one or more processors (e.g., CPU) to a low power mode, triggering system-wide task suspension, activating memory self-refresh, and/or other power-saving hardware features. A set of hardware configurations or states for low power consumption may be referred to as a suspend state.

A device or system may support multiple suspend states. Each suspend state may be associated with (mapped to) a set of hardware states, power usage, and/or a resume latency (time delay to exit the suspend state). Multiple devices and/or systems may have the same suspend state (e.g., suspend-to-idle) but associate (map) that suspend state to partially or completely different sets of hardware configurations. By way of example, consider two systems including different CPUs. One of the CPUs may support a power state for a first power consumption and the other of the CPUs may support a power state for a second power consumption that is lower than the first power consumption. However, both systems may transition to a lowest power state to enter a suspend-to-idle state.

A system activity governor (SAG) is a component of a system that manages power levels of components of that system and/or power states of that system. A SAG may be responsible for determining when to transition a component of that system from one power level to another power level, or a system from one power state to another power state. A SAG may serve as a governor (limiter) on the ability of a system to execute code to transition that system to a suspend state. It may be beneficial to prevent transitions to a suspend state when critical operations are in progress. By way of example, if a user is watching a video on a device or system, then that device or system should not attempt to enter a suspend state while the video is playing.

A SAG may be associated with a power element. A SAG may include logic (e.g., logic specific for a domain) for initialization, state management, and handling for power level changes. A SAG may include an interface definition language service, which may provide access to statistics associated with suspend and/or resume. An interface definition language service may enable clients to keep hardware and/or software awake, and be notified of suspend and/or resume transitions.

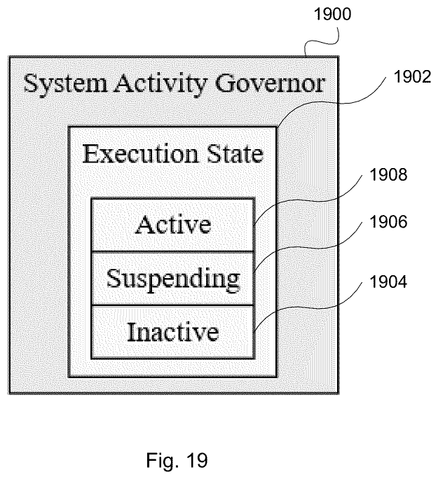

FIG. 19 illustrates an example execution state power element 1902 and a SAG 1900 in accordance with aspects of the technology. The SAG 1900 may generate and manage (or manage without generating) the execution state power element 1902. Execution state of a system or device refers to an ability for hardware and/or software of that system or device to run software, process requests, and/or service requests. The SAG 1900 is the owner of the execution state power element 1902. The execution state power element 1902 may aggregate signals from other components of the system or device, to determine when to attempt a suspend transition.

The SAG 1900, via the execution state power element 1902, may allow other components of the system or device to raise the power level of the power element 1902, if those components have a claim (e.g., an assertive claim) to do so. The SAG 1900, via the execution state power element 1902, may allow components of the system or device to convey that those components need a CPU to continue running software, processing requests, and/or servicing requests. Corresponding power elements and their dependency chains may provide developers, for example, a view of reasoning for why those components those components need a CPU to continue running software, processing requests, and/or servicing requests. By way of example, if a dependency chain is an ultrasound agent, then a developer may infer why a CPU is running software, processing requests, and/or servicing requests. The SAG 1900, via the execution state power element 1902, may allow other components of the system or device to respond to changes in the execution state of the system or device via opportunistic claims. This may allow the SAG 1900 to cause side effects in response to changes in power level of each power element dependent on the execution state power element 1902. Examples of side effects include, but are not limited to, switching off hardware if the system is going into suspend, disabling an interrupt if the system is going into suspend so that hardware will not wake the system, and/or enabling interrupts when the system is resuming so that hardware functions as expected. The SAG 1900, via the execution state power element 1902, may allow other components of the system or device to cause other power elements to be at lower, or lowest, power levels. This may be achieved by a governing action on the execution state power element 1902 when all power elements depending on the power element 1902 are inactive.

The execution state power element 1902 has an “active” power level 1908, a “suspending” power level 1906, and an “inactive” power level 1904. If hardware and/or software of the system or device is running normally, then the execution state power element 1902 may be at the active power level 1908. If hardware and/or software of the system or device is in a suspend state or actively attempting to transition to a suspend state, then the execution state power element 1902 may be at the inactive power level 1904. When the execution state power element 1902 is at the inactive power level 1904, only components of the system or device that are not power-aware, or are power-agnostic, may be running. The suspending power level 1906 is between the inactive power level 1904 and the active power level 1908. The suspending power level 1906 separates power dependencies that are allowed to run only if particular hardware and/or software of the system or device is running from power dependencies that are allowed to run if that particular hardware and/or software of the system or device is transitioning between a suspend state and a running state.

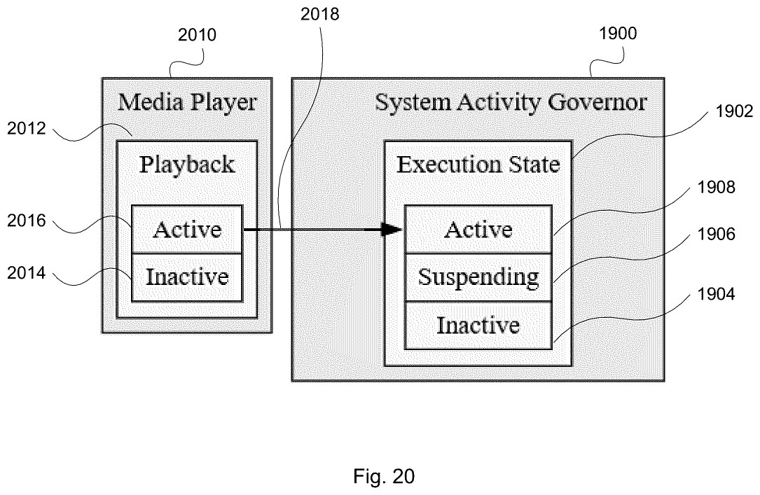

FIG. 20 illustrates an example power element 2012 having a power level dependency on the execution state power element 1902 in accordance with aspects of the technology. To prevent hardware and/or software of the system or device from suspending, that hardware and/or software of the system or device may have a corresponding power element having an assertive power level dependency on the execution state power element 1902. An opportunistic dependency may be used instead of an assertive dependency if another power element has already caused the power level of the execution state power element 1902 to be raised to the active power level 1908.

In the example of FIG. 20 a media player 2010 of a system or device is the owner of a playback power element 2012. The playback power element 2012 has an “inactive” power level 2014 and an “active” power level 2016. Here, it is desired that media playback prevent hardware and/or software of the system or device from suspending in order to support continuous media playback. To do so, the media player 2010, which manages playback state via the playback power element 2012, has an assertive power level dependency 2018 on the execution state power element 1902 to prevent the SAG 1900 from triggering a suspend transition.

The playback power element 2012 has the assertive power level dependency 2018 on the active power level 1908 of the execution state power element 1902. By way of example, when media playback is to start, the media player 2010 may request a lease, from a power broker, for the active power level 2016 of the playback power element 2012. This may prevent hardware and/or software of the system or device from suspending. After that lease is satisfied, the media player 2010 may execute media playback logic without hardware and/or software of the system or device suspending unexpectedly.

An execution state power element may be used to constrain a power level of a component of a system or device. By way of example, power consumption of a peripheral component of the system or device may be tied to a suspend state of hardware and/or software of the system or device. As hardware and/or software of the system or device transitions to a suspend state, a driver associated with that peripheral component can power down the peripheral component or change a configuration of the peripheral component. Constraining a power level may be useful to power down specific components when hardware and/or software of the system or device suspends to reduce power consumption.

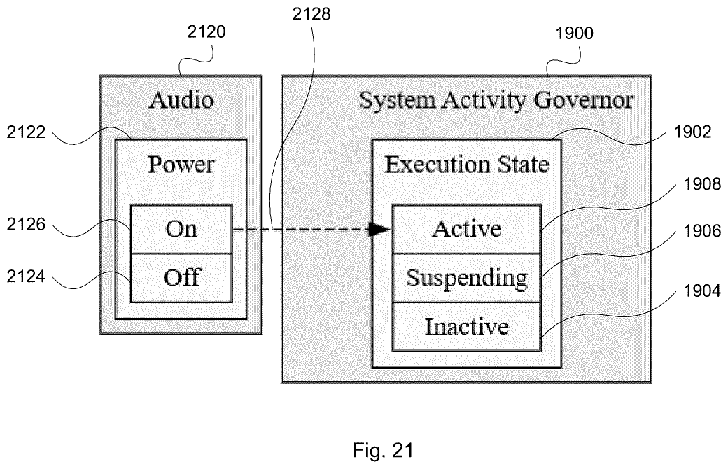

FIG. 21 illustrates an example power element 2122 having a power level dependency on the execution state power element 1902 in accordance with aspects of the technology. FIG. 21 shows an audio driver 2120 of a system or device being the owner of a “power” power element 2122. The “power” power element 2122 has an “off” power level 2124 and an “on” power level 2126. The audio driver 2120 has an opportunistic power level dependency 2128 on the execution state power element 1902. The audio driver 2120 can monitor its dependencies to be fulfilled by requesting a lease from a power broker of the system or device.

When the execution state power element 1902 transitions to the active power level 1908, the lease on the “power” power element 2122 will be satisfied. At that time, the audio driver 2120 can activate audio hardware. Conversely, when the execution state power element 1902 transitions from the active power level 1908, the lease on the “power” power element 2122 becomes unsatisfied. At that time, the audio driver 2120 can deactivate the audio hardware (prior to notifying the power broker that the “power” power element 2122 has lowered its power level.

When hardware and/or software of a system or device is suspended, that hardware and/or software may be resumed by an external stimulus. By way of example, such an external stimulus may be a CPU interrupt that is raised by a peripheral component of the system or device. To properly handle a waking interrupt, wake vectors for drivers may be programmed before suspension. When handling an interrupt, if a driver is waiting on a port for an interrupt, its interrupt handler thread (IHT) may be scheduled by a kernel or the system or device. The IHT, or another component notified by the IHT, may request a lease in order to block or prevent suspension of hardware and/or software of the system or device. The driver communicates with the hardware and/or software as required to handle the interrupt. During this time, other components may request leases. When handing the interrupt is complete, the driver may call an acknowledgment function (e.g., interrupt_ack).

Some drivers may call an acknowledgment function as soon as possible for asynchronous interrupt handling and/or data handling in hardware. In such a case, a driver (or its delegates) may acquire a lease that raises the power level of the execution state power element 1902 to at least the suspending power level 1906. This lease may be active until handing the interrupt is complete. While an interrupt is being handled, the SAG 1900 may run at any time because the kernel resumes tasks that were suspended as a result of hardware and/or software of a system or device transitioning to suspend.

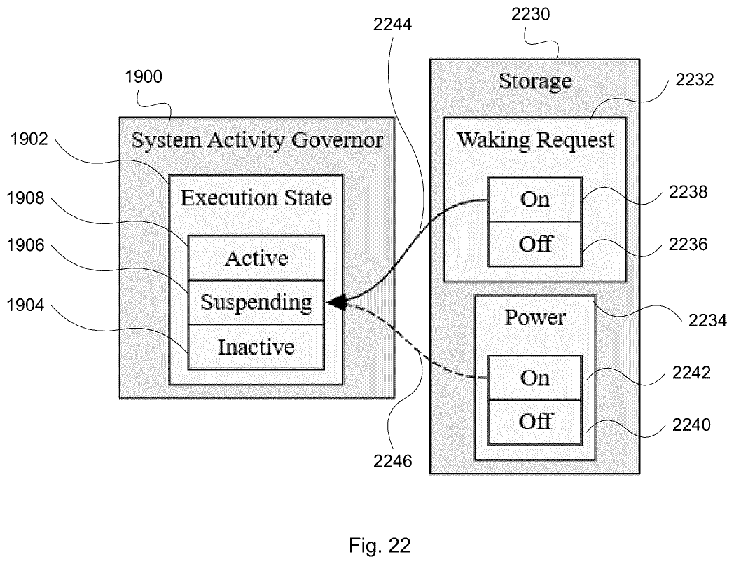

FIG. 22 illustrates example power elements 2232 and 2234 having dependencies on the execution state power element 1902 in accordance with aspects of the technology. FIG. 22 shows a storage driver 2230 of a system or device being the owner of a “waking request” power element 2232 and a “power” power element 2234. The waking request power element 2232 has an “off” power level 2236 and an “on” power level 2238. The “power” power element 2234 has an “off” power level 2240 and an “on” power level 2242. The storage driver 2230 has an assertive power level dependency 2244 and an opportunistic power level dependency 2246 on the execution state power element 1902.

Although the storage driver 2230 may follow a similar approach as the audio driver 2120 in that the storage driver 2230 (and hardware associated therewith) is normally turned off (e.g., at the off power level 2240) when hardware and/or software of a system or device is suspended, the storage driver 2230 would also be turned off while the hardware and/or software of the system or device is transitioning to suspend or resuming to service a waking interrupt. This may cause issues if a component of the system or device that is currently paged out is powering down and needs to perform cleanup operations before suspended. Because the order of power-down operations is not deterministic, the approach used by the audio driver 2120 is insufficient for the storage driver 2230.

The on power level 2240 of the “power” power element 2234 has the opportunistic power level dependency 2246 on the suspending power level 1906. The opportunistic power level dependency 2246 is satisfied if another power element raises the execution state power element 1902 to at least the suspending power level 1906. As long as the storage driver 2230 holds a lease on the on power level 2240 after the storage driver 2230 raises the execution state power element 1902 to at least the suspending power level 1906, the execution state power element 1902 cannot lower from the suspending power level 1906. This enables the storage driver 2230 to monitor if the storage driver 2230 should power down.

The on power level 2236 of the waking request power element 2232 has the assertive power level dependency 2242 on the suspending power level 1906. The assertive power level dependency 2244 forces the execution state power element 1902 to raise to at least the suspending power level 1906 when the waking request power element 2232 is at the on power level 2236. The storage driver 2230 may request a lease for the waking request power element 2232 to be at the on power level 2236 when the storage driver 2230 receives a storage request. This enables the storage driver 2230 (and hardware associated therewith) to power up, even while other parts of the system or device are powering down.

When the SAG 1900 is initialized, the SAG 1900 may not trigger a suspension until the system or device has completed a boot process. While in this booting state, the execution state power element 1902 may be at the active power level 1908 to reflect that the hardware and/or software of the system or device is actively running and not attempting to suspend. During this time, other components of the system or device may generate power level dependencies and/or request leases that affect the execution state power element 1902. However, the execution state power element 1902 may be at the active power level 1908 until the boot process completes. To exit the booting state, an IDL service hosted by the SAG 1900 may be notified that the booting process is complete. This IDL service may be used if higher layers of the system or device can express their power needs, (e.g., by the session via user interaction).

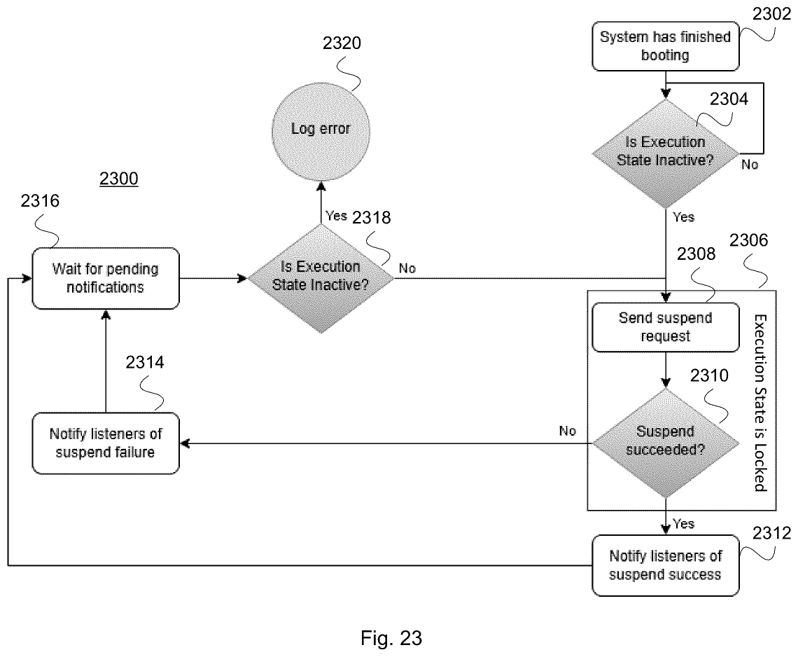

FIG. 23 illustrates an example suspend flow 2300 in accordance with aspects of the technology. At 2302, the system (or device) has completed booting. Requests to transition to suspend may be made if the execution state power element 1902 is at the inactive power level 1904, its lowest power level. At 2304, whether the execution state power element 1902 is at the inactive power level 1904 is determined. If the execution state power element 1902 is not at the inactive power level 1904, the suspend flow 2300 loops back to determine whether the execution state power element 1902 is at the inactive power level 1904. If whether the execution state power element 1902 is at the inactive power level 1904, then the suspend flow 2300 proceeds.

Before initiating a transition to suspend, the SAG 1900 may inform registered listeners that a suspend is about to occur. A listener may be software waiting for a signal. Registering a listener may include specifying a callback routine to be called at a later time. The SAG 1900 may handle potential races between the SAG 1900, a power broker, and/or an interrupt-handling driver. While a suspend request is in progress, the SAG 1900 may not change the power level of the execution state power element 1902. When the SAG 1900 resumes from being suspended, the execution state power element 1902 may be at the inactive power level 1904. Components and their corresponding power elements that depend on the execution state power element 1902 transition to, and stay at, their respective power levels immediately before and during the transition to suspend. Here, at 2306, the SAG 1900 locks the execution state power element 1902 at the inactive power level 1904 by delaying the processing of other power level changes requested by the power broker.

At 2308, the SAG 1900 communicates a suspend request. When the hardware and/or software of the system or device resumes (e.g., in response to a trigger, such as a timer, and/or user input), at 2310, the SAG 1900 may receive the result of the suspend request. The SAG 1900 may notify listeners of the result of the suspend request.

If the requested suspension succeeded, then, at 2312, the SAG 1900 notifies registered listeners of the successful suspension. At that time, registered listeners may request a lease that blocks suspension of the hardware and/or software of the system or device. By requesting a lease on the execution state power element 1902, registered listeners may prevent further suspension because registered listeners might have to respond or service an interrupt. This may be referred to as a wake-lease. A suspend hardware abstraction layer (HAL) may return an error if a waking interrupt has not been acknowledged. This prevents a race where the SAG 1900 executes before the interrupt handler has a chance to request a lease and acknowledge the interrupt. A driver, or interrupt handler, may request a lease before acknowledging an interrupt if that driver executes work afterwards.

If a suspend request fails, then, at 2314, the SAG 1900 notifies listeners of that failure. A suspend request may fail before a transition occurs such that the requested suspension fails. By way of example, this may be caused by a pending interrupt that wakes (e.g., wakes immediately) the hardware and/or software of the system or device, or an error in the suspend HAL or kernel. This may enable components of the system or device to request leases and change configuration of the system so as to prevent repeated sending of suspend requests that will ultimately fail.

At 2316, the SAG 1900 waits for acknowledgments to the notifications of success or failure of the suspension. At 2318, whether the execution state power element 1902 is at the inactive power level 1904 is determined. If no listener raises the execution state power element 1902 from the inactive power level 1904 (e.g., during a resume transition), then at 2320, the SAG 1900 logs this error (e.g., a failure). Such a scenario may occur if one or more listeners crash, for example.

If a shutdown or reboot is requested by a component of a system or device, a component manager may begin terminating components based on a graph. This may cause complications if components that are keeping hardware and/or software of the system or device from suspending are powered down before the SAG 1900 because the SAG 1900 may erroneously trigger a suspension while the shutdown or reboot is in progress. To address this, components responsible for coordinating shutdown or reboot (e.g., power broker) may hold a lease to keep the execution state power element 1902 at the suspending power level 1906. Because the shutdown-shim and/or the power broker may be some of the last components to be powered down as part of a reboot, keeping the execution state power element 1902 at the suspending power level 1906 may prevent erroneous suspensions.

Battery life of wearable devices is a factor in overall user satisfaction. Power savings may be provided by managing power states of hardware of wearable devices efficiently and/or using synthetic power states that enable representation of dependencies between power states and an on-demand usage model based on those dependencies. A synthetic power state refers to a power state that does not map directly to a hardware power state such that the power state is created “artificially” to represent dependencies between power states and an on-demand usage model based on those dependencies. These synthetic power states may provide improved power consumption, functionality and/or wake latency over other approaches. Other approaches that use power models may underestimate actual power consumption of certain user journeys, sometimes by a factor of at least two. Such discrepancies between power models and real-world data may be caused by parasitic workloads (described further herein).

Aspects of the technology include optimizing management of parasitic workloads to improve overall power efficiency. Other aspects of the technology include a component-oriented architecture in which functional subsystems may be represented by (e.g., broken down into) a hierarchy of components. Although these components may communicate with each other via peer-to-peer, asynchronous inter-process-communication, a centralized power management framework may manage the overall power state of a system or device. Based on current tasks and future, projected tasks for components, this power management framework may determine optimum power states for the system or device. Components may request leases on power elements. Leases may relate components and power levels thereof to hardware power states. This power management framework may integrate a kernel scheduler to control which components are authorized to execute tasks at any given time based on these leases, which may express a user's current needs.

A MCU may be an embedded sub-system and may include a processor (e.g., CPU), memory, and peripheral(s) on a single chip. An AP may be a general purpose processor responsible for tasks (e.g., primary tasks associated with running operating systems and/or applications. An AP may be considered as a “brain” of the device, controlling various functions and enabling a user to interact with operating systems and/or applications. MCUs may be responsible for tasks associated with (e.g., requiring) low power, real-time operation, and/or cost-effectiveness. APs, on the other hand, may be more powerful than MCUs and provide greater processing capabilities (e.g., for running operating systems).

By way of example, a microcontroller unit (MCU) may collect sensor data if an application processor (AP) is in a low power state. When the MCU exhausts its buffers, the AP may be awoken and buffered sensor data may be flushed to persistent storage. Aspects of the technology include, when the AP is awoken to flush sensor data to persistent storage, a sensor driver may request a lease on a corresponding power element that has a power level dependency on a storage subsystem. When a sensor HAL communicates with a component (e.g., file system) to persist the sensor data, the storage subsystem may be authorized to execute tasks because its corresponding power element has been activated according to the power management framework. However, if the sensor HAL sends a message to an inactive subsystem, then that message will be queued in the kernel and not processed until that inactive subsystem is authorized to run (e.g., via asynchronous message passing).

By way of example, updating a display of a wearable device (e.g., watch face) may be offloaded to the MCU and the AP may be put in a low power state. For example, if a display update includes a notification to be displayed, then the AP may need to be woken up. But, if a display update does not include a notification to be displayed, then the AP may not need to be woken up and the MCU can manage tasks associated with that display update. As another example, when a user interacts with the wearable device (e.g., by raising a wrist, tapping on the display), the AP may be awoken and control of the display may be transferred back to the AP. Offloading display updates to the MCU may save power, but at a cost to user experience. When a user interacts with the wearable device, the wearable device may compensate for the time for the AP to resume and take control of the display to avoid user-visible latency. However, avoiding user-visible latency limits when display updates may be offloaded to the MCU.

Offloading display updates to the MCU may include changing from running software for those display updates via an application running in a first OS to running the software in a second OS that is outside the context of the first OS, even if memory is shared across the AP and the MCU. Offloading display updates to the MCU may include changing the execution of that software from the AP to the MCU.

Aspects of the technology include the second OS serving as a supervisor for the first OS. Thus, the software for display updates may stay executed on the AP without offloading to the MCU. In this mode, the second OS may suspend the first OS (e.g., suspend the first OS entirely) and execute the software for display updates as a component according to the power management framework. The second OS may put the AP into a minimal power state (e.g., by taking one or more cores of the AP offline), and limit the AP to performing tasks only to update the display.

If a user interacts with the device, the device may resume from the low power state with less latency because a kernel running on the AP may begin scheduling threads in a container of the first OS without waiting for the AP to raise from the low power state. If additional performance is needed, the second OS may raise the power state of the AP from the low power state (e.g., by taking one or more cores of the AP online) in parallel with executing the threads in the container of the first OS.

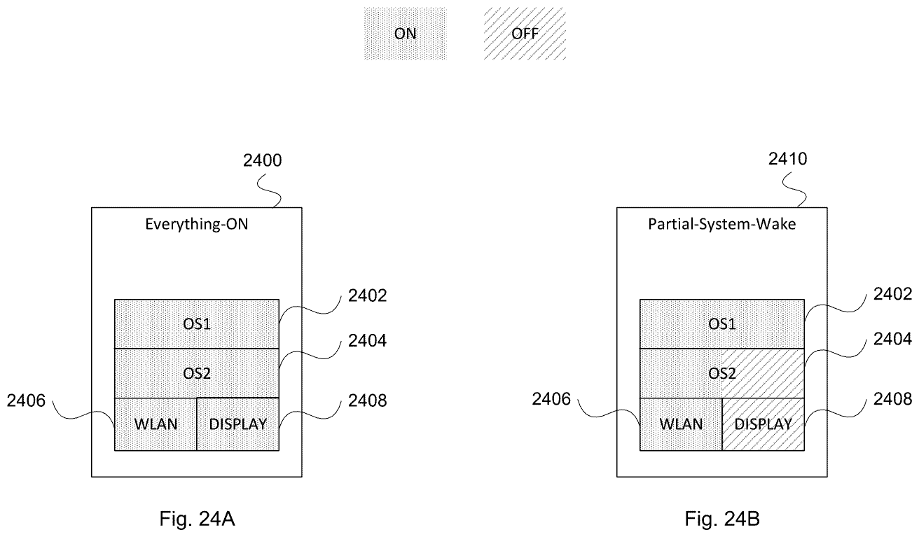

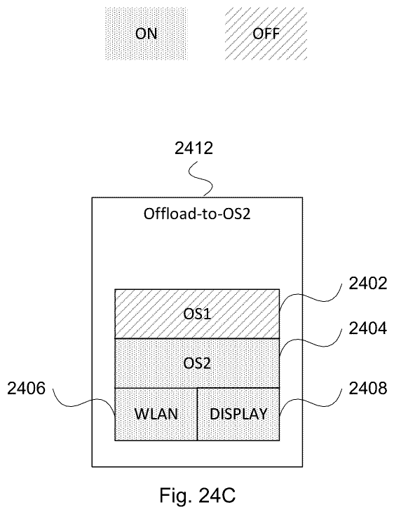

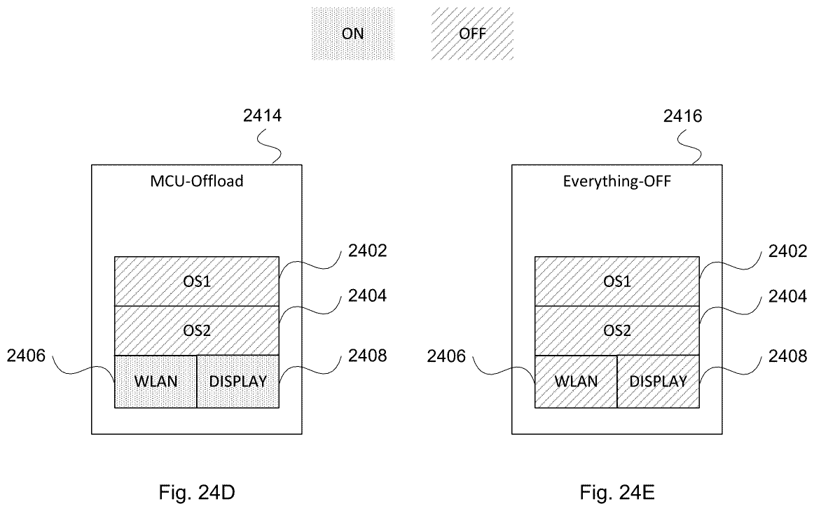

FIGS. 24A-E illustrate block diagram representations of example synthetic power states of a device (e.g., a wearable device) in accordance with aspects of the technology. These synthetic power states provide a granular and observable way to manage power states throughout a device in a variety of operating modes. FIGS. 24A-E show block representations of a first OS (OS1) 2402, a second OS (OS2) 2404, wireless local area network (WLAN) 2406, and display 2408 of a device. However, synthetic power states are not limited to these components shown in FIGS. 24A-E. Here, in these example synthetic power states, OS2 2404 supervises OS1 2402.

FIG. 24A is a block diagram representation of “everything-on” power state 2400. As the name implies, in this everything-on power state 2400, OS1 2402, OS2 2404, the WLAN 2406, and the display 2408 are active (e.g., turned on). However, one or more hardware components may be put into low-power states, but everything that executes on an AP is authorized. In the everything-on power state 2400, power may be consumed via direct power consumption from task execution, indirect power consumption from hardware components that are activated but not used (e.g., not needed), and/or indirect power consumption from delaying completion of a task by the AP for which the AP was awoken.

FIG. 24B is a block diagram representation of partial-system-wake power state 2410. In the partial-system-wake power state 2410, OS1 2402 is running and a power management framework is limiting tasks that OS2 2404 performs on behalf of OS2 2404 and on behalf of OS1 2402. Here, OS2 2404 saves power by delaying servicing of requests associated with inactive subsystems of the device (e.g., subsystems may be inactive if there is no immediate tasks to be performed) until a more efficient time. By way of example, it may be more efficient to group tasks such that a device wakes up less, saving the cost of additional suspend/resume cycles. For instance, delaying performance of a storage maintenance operation because not performing that storage maintenance operation at a particular time does not significantly affect the device's performance. OS2 2404 does not turn on a peripheral component (e.g., the display 2408) until that peripheral component is needed by OS1 2402.

FIG. 24C is a block diagram representation of offload-to-OS2 power state 2412. In this offload to OS2 power state 2412, OS1 2402 is suspended but OS2 2404 is still running on the AP. The offload-to-OS2 power state 2412 may be entered by OS1 2402 explicitly offloading workloads to OS2 2404 (e.g., updating the display). The offload-to-OS2 power state 2412 may be entered because a MCU awakens the AP for workloads that may be completed without OS1 2402. The offload-to-OS2 power state 2412 can be combined with the partial-system-wake power state 2410 so as to turn on necessary hardware and software components. In such a combined power state, OS2 2404 saves power by avoiding parasitic workloads.

FIG. 24D is a block diagram representation of MCU-offload power state 2414. In the MCU-offload power state 2414, control of the WLAN 2406 and the display 2408 is entirely offloaded to the MCU as both OS1 2402 and OS2 2404 are inactive (e.g., turned off) alone. By way of example, although not specifically illustrated, in the MCU-offload power state 2414, a digital signal processor (DSP) of a device (e.g., an audio DSP) may be active (e.g., awake), while other components of that device remain asleep. Power consumption and/or parasitic workloads of a device may be reduced, or even minimalized, by restricting which application or applications are allowed to run on that device without waking up an AP of that device, and an operating system associated therewith (e.g., OS1 2402). Parasitic workloads (also referred to as opportunistic workloads) includes software executed on the AP even if that software is not part of a user journey. Thus, parasitic workloads cause additional power consumption, directly and/or indirectly, by utilizing more resources of the AP and/or other subsystems and hardware of a system or device. A wearable device or a mobile device may have many applications (apps) installed thereon, which may “race” to run upon waking up of that wearable device or mobile device.

FIG. 24E is a block diagram representation of everything-off power state 2416. As the name implies, in the everything-off power state 2416, OS1 2402, OS2 2404, the WLAN 2406, and the display 2408 are inactive (e.g., turned off).

Other approaches that rely on power models underestimate the actual amount of power consumed by modeled user journeys by at least a factor of 2× to 3×. Because these power models are based on data “clean” benchmark-style testing, the power models do not accurately account for parasitic workloads from real-world use. Actual user engagement relative to power usage uses significantly more power than estimated by power models. By way of example, modeled users and real-world users who are less engaged with a device than those modeled users use a comparable amount of power, despite the lesser engagement.

Aspects of the technology include an OS having the power management framework described herein serving as a supervisor for another OS. Via this power management framework, hardware power states may be used more efficiently. Moreover, synthetic power states may be used that enable an AP to execute workloads on behalf of a user while avoiding parasitic workloads. Thus, the technology may decrease power usage with less costly user experience tradeoffs than other approaches.

### Example Computing System

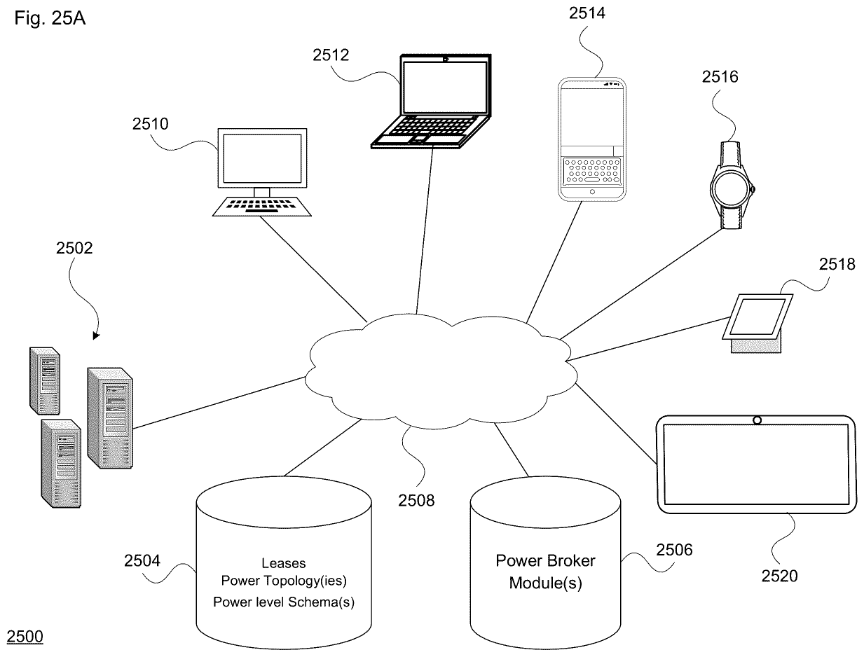

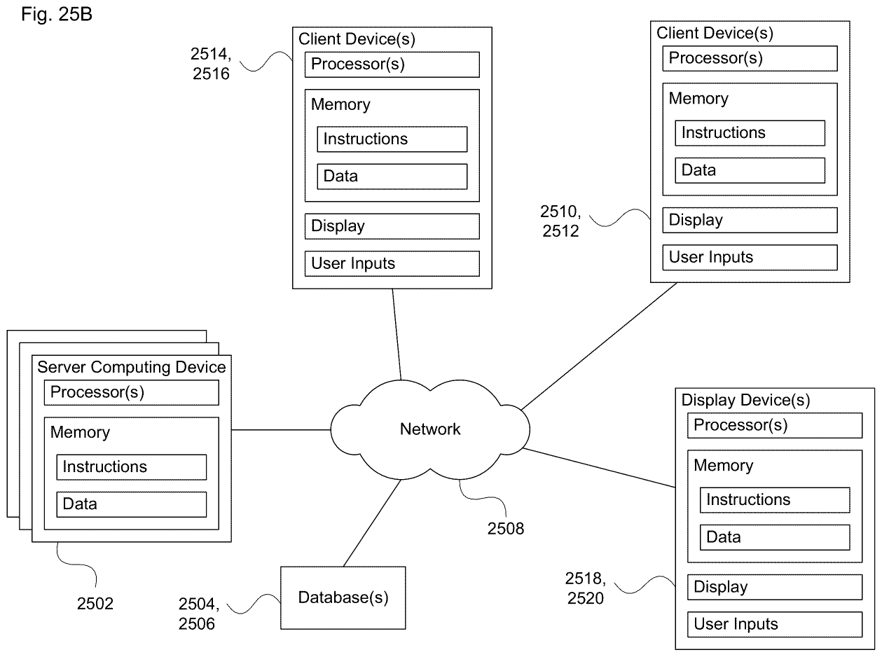

The approaches described herein may be implemented using various types of computing devices and architectures. One example computing architecture is shown in FIGS. 25A and 25B. In particular, FIGS. 25A and 25B are pictorial and functional diagrams, respectively, of an example system 2500 that includes a plurality of computing devices and databases connected via a network. The computing device(s) 2502 may implement a power broker (or a set of power brokers) and a power topology (or set of power topologies) as described herein. The computing devices 2502 may comprise one or more tensor processing units (TPUs), graphics processing units (GPUs), CPUs or other computing architectures.

Databases 2504 and 2506 may store, e.g., leases, power topologies, power level schemas and/or power broker modules, etc. Or such elements may be maintained directly on the devices of interest. The server system may access the databases via network 2508. Client devices may include one or more of a desktop computer 2510, a laptop or tablet PC 2512, a mobile phone 2514, a wearable device such as a smartwatch 2516, etc. Other types of client devices may include a smart display 2518 and/or a whiteboard or other type of display 2520.

As shown in FIG. 25B, each of the computing devices 2502 and 2510-2516 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, GPUs, etc. Alternatively, each processor may be a dedicated device such as an ASIC or other hardware-based processor. Although FIG. 25B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 2502. Accordingly, references to a processor or computing device will be understood to include references to a collection of processors or computing devices or memories that may or may not operate in parallel.

Reference to “one or more processors” herein includes situations where a set of processors (e.g., two or more CPUs, TPUs, GPUs or any combination thereof) may be configured to perform one or more operations. Any combination of such a set of processors may perform individual operations or a group of operations. Therefore, reference to “one or more processors” does not require that all processors in the set must perform all of the operations. Rather, unless expressly stated, any one (or different combinations) of the one or more processors may perform different operations when a set of operations is indicated. For instance, different processors may perform specific operations. For example, a first processor may implement a power broker, including managing leases, power topologies and/or power level schemas, while one or more second processors performs application-specific operations (e.g., airplane mode) and/or component-specific operations (such as management of a USB device, a Bluetooth™ radio or a WiFi radio).

The computing devices may utilize such information in various apps or other programs to perform various operations and functions. The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-focused types of computing devices (e.g., 2510-2520) may communicate with a back-end computing system (e.g., server 2502) via one or more networks, such as network 2508. The network 2512, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 2502 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 2502 may include one or more server computing devices that are capable of communicating with any of the computing devices 2510-2520 via the network 2508.

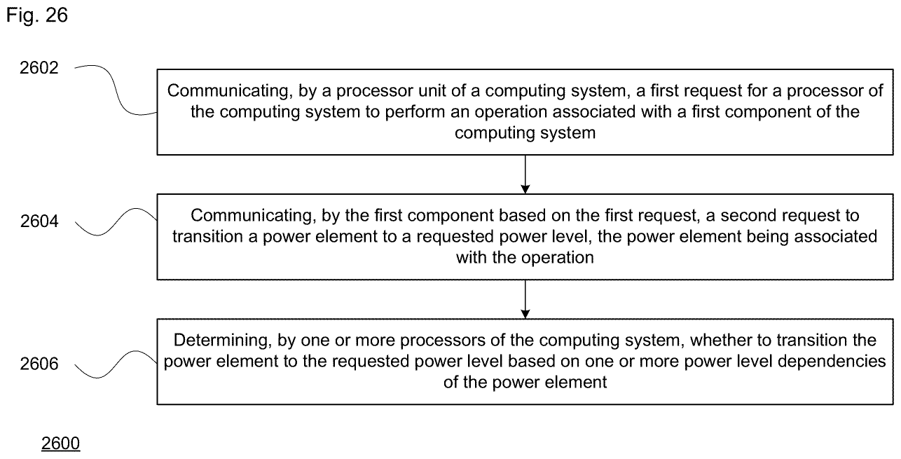

FIG. 26 illustrates an example method 2600 in accordance with the above discussion. The method 2600 includes, at block 2602, communicating, by a processor unit of a computing system, a first request for a processor of the computing system to perform an operation associated with a first component of the computing system. The method 2600 includes, at block 2604, communicating, by the first component based on the first request, a second request to transition a power element to a requested power level, the power element being associated with the operation. The method 2600 includes, at block 2606, determining, by one or more processors of the computing system, whether to transition the power element to the requested power level based on one or more power level dependencies of the power element

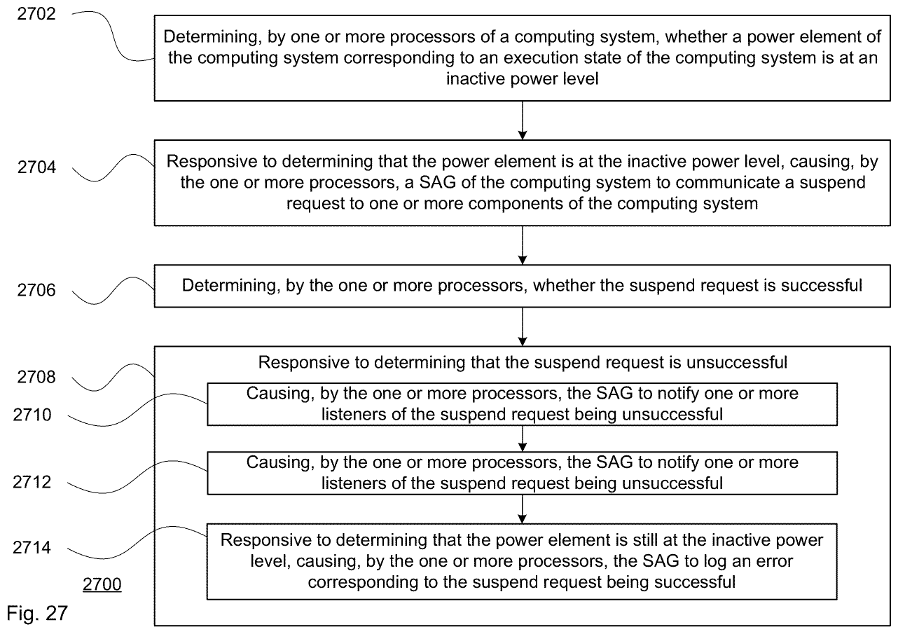

FIG. 27 illustrates an example method 2700 in accordance with the above discussion. The method 2700 includes, at block 2702, determining, by one or more processors of a computing system, whether a power element of the computing system corresponding to an execution state of the computing system is at an inactive power level. The method 2700 includes, at block 2704, responsive to determining that the power element is at the inactive power level, causing, by the one or more processors, a SAG of the computing system to communicate a suspend request to one or more components of the computing system. The method 2700 includes, at block 2706, determining, by the one or more processors, whether the suspend request is successful. The method 2700 includes, at block 2708, responsive to determining that the suspend request is unsuccessful: causing, by the one or more processors, the SAG to notify one or more listeners of the suspend request being unsuccessful at block 2710, causing, by the one or more processors, the SAG to notify one or more listeners of the suspend request being unsuccessful at block 2712, and responsive to determining that the power element is still at the inactive power level, causing, by the one or more processors, the SAG to log an error corresponding to the suspend request being successful at block 2714.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A method comprising:
communicating, by a processor unit of a computing system, a first request for a processor of the computing system to perform an operation associated with a first component of the computing system;
communicating, by the first component based on the first request, a second request to transition a power element to a requested power level, the power element being associated with the operation; and
determining, by one or more processors of the computing system, whether to transition the power element to the requested power level based on one or more power level dependencies of the power element.

2. The method of claim 1, wherein the computing system comprises a wearable device.

3. The method of claim 1, wherein the computing system comprises a mobile device.

4. The method of claim 1, further comprising, responsive to determining not to transition the power element to the requested power level, queuing a message associated with the operation in a kernel of the computing system.

5. A computing system comprising:
a first processor;
a second processor that is different from the first processor; and
a processor unit operatively couples to the first processor and the second processor;
wherein the first processor is configured to:
cause the second processor to be in a low power level; and
while the second processor is in the low power level, cause offload of one or more operations associated with the second processor to the processor unit.

6. The computing system of claim 5, wherein:
the second processor is associated with a first operating system (OS) of the computing system,
the processor unit is associated with a second OS of the computing system, and
the second OS is different from the first OS.

7. The computing system of claim 6, wherein:
the first processor comprises a microcontroller unit (MCU), and
the second processor comprises an application processor (AP).

8. The computing system of claim 6, wherein the first processor is configured to cause the second processor to be in the low power level by being further configured to cause suspension of the first OS.

9. The computing system of claim 5, wherein memory is shared by the processor unit and the second processor.

10. The computing system of claim 5, wherein the computing system is a wearable device.

11. The computing system of claim 10, wherein:
the wearable device includes a display; and
the first processor is further configured to:
responsive to receipt of a first display update task associated with a notification to be displayed on the display, cause the second processor to transition from the low power level to an active power level; and
responsive to receipt of a second display update task that is not associated with a notification to be displayed on the display, cause the processor unit to perform one or more operations associated with the second display update task.

12. A method comprising:
determining, by one or more processors of a computing system, whether a power element of the computing system corresponding to an execution state of the computing system is at an inactive power level;
responsive to determining that the power element is at the inactive power level, causing, by the one or more processors, a system activity governor (SAG) of the computing system to communicate a suspend request to one or more components of the computing system;
determining, by the one or more processors, whether the suspend request is successful; and
responsive to determining that the suspend request is unsuccessful:
causing, by the one or more processors, the SAG to notify one or more listeners of the suspend request being unsuccessful;
determining, by the one or more processors, whether the power element is still at the inactive power level; and
responsive to determining that the power element is still at the inactive power level, causing, by the one or more processors, the SAG to log an error corresponding to the suspend request being successful.

13. The method of claim 12, wherein the computing system comprises a wearable device.

14. The method of claim 12, wherein the computing system comprises a mobile device.

15. The method of claim 12, wherein determining whether the power element is still at the inactive power level is responsive to receiving, by the SAG from the one or more listeners, acknowledgment of the notification of the suspend request being unsuccessful.

16. The method of claim 12, further comprising, responsive to determining that the power element is at the inactive power level, causing, by the one or more processors, the SAG to lock the power element at the inactive power level.

17. The method of claim 12, further comprising, responsive to determining that the power element is at another power level higher than the inactive power level:
causing, by the one or more processors, the SAG to communicate another suspend request to the one or more components of the computing system; and
determining, by the one or more processors, whether the other suspend request is successful.

18. A non-transitory computer readable storage medium storing one or more instructions configured for execution by a computing system having one or more processors, the one or more instructions for performing a method comprising:
determining whether a power element of the computing system corresponding to an execution state of the computing system is at an inactive power level;
responsive to determining that the power element is at the inactive power level, causing a system activity governor (SAG) of the computing system to communicate a suspend request to one or more components of the computing system;
determining whether the suspend request is successful; and
responsive to determining that the suspend request is unsuccessful:
causing the SAG to notify one or more listeners of the suspend request being unsuccessful;
determining whether the power element is still at the inactive power level; and
responsive to determining that the power element is still at the inactive power level, causing the SAG to log an error corresponding to the suspend request being successful.

19. The non-transitory computer readable storage medium of claim 18, wherein determining whether the power element is still at the inactive power level is responsive to receiving, by the SAG from the one or more listeners, acknowledgment of the notification of the suspend request being unsuccessful.

20. The non-transitory computer readable storage medium of claim 18, the method further comprising, responsive to determining that the power element is at the inactive power level, causing, by the one or more processors, the SAG to lock the power element at the inactive power level.
